(19) United States
(12) Patent Application Publication
(10) Pub. No.: US 2018/0246743 A1
(43) Pub. Date: Aug. 30, 2018

(54) Embedded System Enabling On-Line Collaborative Migration of Software Execution Environments

(71) Applicant: HAUTE ECOLE D'INGENIERIE ET DE GESTION DU CANTON DE VAUD (HEIG-VD), Yverdon-les-Bains (CH)

(72) Inventor: Daniel Rossier, Cousset (CH)

(21) Appl. No.: 15/527,106

(22) PCT Filed: Nov. 27, 2015
(86) PCT No.: PCT/IB2015/059187

§ 371 Date: May 16, 2017

(30) Foreign Application Priority Data
Nov. 27, 2014 (EP) 14195123.6

(51) Int. Cl. G06F 9/455; G06F 9/54; G06F 8/60; H04L 29/08

(52) U.S. Cl. CPC G06F 9/45533; G06F 9/547; G06F 2009/45579; H04L 67/34; G06F 2009/4557; G06F 8/60

(57) ABSTRACT

The present invention provides an embedded system for operating a peripheral, wherein said peripheral may be any electronically supported device, in particular a device that is operated by firmware. The embedded system is external to the peripheral and contains an interface for connection to the peripheral. Each of said external embedded systems comprises a dedicated communication module, which allows it to build up a network with one or more other embedded systems of the same type, in as far as such other systems are in reach to build up the network. The embedded system is configured to transmit and receive mobile software entities (MEs), each containing an own operating system (OS). As an advantage, the present invention provides a new model or platform enabling efficient dissemination of software and highly collaborative environments. The invention provides a powerful and permanent dissemination of complete execution environments over distributed platforms.

### TECHNICAL FIELD

The present invention relates to a data processing device and/or an embedded system for operating an electrically and/or electronically supported peripheral, to an embedded system comprising software producing a virtualized environment of hardware components of the device and configured to broadcast and/or receive mobile software entities (MEs); to MEs; to methods for operating an electrically and/or electronically supported peripheral and of operating the device/system of the invention, and to various further methods and uses as set out in this specification.

### PRIOR ART AND THE PROBLEM UNDERLYING THE INVENTION

Today, most electrically and electronically supported apparatuses, appliances and peripherals comprise or are dependent on an embedded system. Embedded systems control many devices in common use today, such as consumer, cooking, industrial, automotive, medical, commercial and military applications or appliances. The embedded computer system is frequently part of a larger device that may contain mechanical parts and/or hardware. Program instructions of embedded systems are often stored in the form of firmware in read-only memory or flash memory chips.

Typically, an embedded system is a computer system that is dedicated to handle a particular task. Due to the dedicated nature, an embedded system is generally specialized and thus in many aspects (software, hardware) smaller than general-purpose computers.

The present inventors are concerned about the following, current challenges associated with embedded systems:

There is first a problem concerned with the software and/or firmware that is used to operate a particular apparatus or peripheral. For various reasons, it can be appropriate to update such software. One reason is that new software can provide new functionalities and result in a better performance of the peripheral. For example, new software may be capable of operating a given peripheral in a more energy-efficient manner or may make use of information that was not taken into account hitherto. The present invention addresses the problem of updating firmware, or, more generally, software for operating electrically and electronically supported apparatuses and peripherals.

One may envisage the use of a network for updating software and/or firmware. In this context, the “Internet of Things” (IoT) provides a current approach of interconnecting uniquely identifiable embedded computing devices within the existing Internet structure. The IoT is expected to offer advanced connectivity of devices and systems. The downside of the IoT is the need of particular protocols, systems architectures and frameworks for connecting a device to the internet. Currently, many manufacturers produce their own protocol for connecting a device to the Internet, adapted to the device, but not compatible with protocols of other manufacturers and other devices. The IoT also poses problems in terms of security and vulnerability to malware, and strongly relies on the Internet network and needs appropriate connections with possible support of specific Quality-of-Service. The present invention seeks to avoid inconveniences associated with the IoT.

If one considers a network for providing software updates to electrically and electronically supported apparatuses and peripherals, there are many open issues to be addressed. For example, how can a particular software update be sent to a particular peripheral that needs updating? How can a network be used to provide other currently used and known functionalities, such as data streaming and instant messaging, for example? Another relevant question is how various protocols and framework versions can co-exist over time.

The present invention is also concerned with the diversity of electrically and electronically supported apparatuses and peripherals and seeks providing a solution that can be applied to all sorts of such peripherals or “things”, even completely unrelated peripherals. The present inventions seeks a manner of connecting completely different and unrelated peripherals and thus enabling a facilitated and efficient transfer of data and software between any type of peripherals or “things”, the term “thing” being employed as understood not only in the expression “IoT”, but also for any “thing” which exposes a digital interface and provides any “programmable” facilities related to the thing such as retrieving data or doing performing specific controls (like configuration, control commands, etc.).

Chien-Liang Fok et al “Rapid Development and Flexible Deployment of Adaptive Wireless Sensor Network Applications” ICSCS'05 (2005) 653-662 disclose wireless sensor networks (WSNs) consisting of a multitude of tiny sensors attached to battery-powered microprocessors. In terms of software architecture, each device is equipped with a TinyOS, on top of which the Agilla middleware is running. Mobile agents containing instruction memory, data memory, program counter, operand stack and heap are introduced through a base station for distribution through the network. Importantly, the embedded system of Fok et al is entirely limited to WSNs in terms of devices that can be controlled. The base station is a required part of the system, for agent introduction and receipt of alarm events. Mobile agents provide the unique execution environment in Agilla, such that the application logic must be coded within the agent itself following a restricted set of instructions in a defined programming language. The agents thus entirely rely on the Agilla middleware and depend on the applicable language. Furthermore, the agents contain and implement their own migration strategy, which renders the ecosystem unstable and subject to collapsing. In view of Fok et al, the present invention has the objective to provide an embedded system that is potentially suitable to control any electronically or electrically controlled peripheral, not just wireless sensors. The invention seeks to address the inconveniences indicated above. The invention also seeks to provide a system of live migration allowing dissemination of mobile entities while they are executed and/or in their current execution state. Such a migration systems is also known as “strong migration”.

The present invention addresses the problems depicted above.

### SUMMARY OF THE INVENTION

Remarkably, the present inventors provide an embedded platform enabling efficient dissemination of software and/or firmware.

In an aspect, the present invention provides a device providing an embedded system/device for interacting with, supporting, managing, operating, driving and/or controlling one or more electrically and/or electronically supported apparatuses and/or, appliances and/or peripherals, the system being configured to connect to and/or communicate with other embedded systems/devices of the same type.

In an aspect, the present invention provides an embedded system and/or device for interacting with, supporting, managing, operating, driving and/or controlling one or more electrically and/or electronically supported apparatuses and/or peripherals, the system being configured to establish, in an automated manner, a connection with other systems of the same type, thereby establishing a network between systems of the invention. The connections between the systems of the invention can be established independently of the peripheral to which the different systems of a network are connected. The network is preferably established between systems of the invention that are in reach with each other, for example by a wireless connection.

In an aspect, the invention provides embedded systems and/or devices comprising a common software platform, allowing the automated establishment of connections between the embedded systems of the invention and the exchange of mobile software entities (MEs) between the embedded systems.

In an embodiment, the present invention provides a multi-purpose embedded system and/or a device comprising the same.

In a preferred embodiment, the system and/or device is configured to load, run, propagate, disseminate and/or receive different software entities, said different software entities being specifically adapted to interact with a particular electrically and/or electronically supported apparatus and/or peripheral, wherein said different software entities differ in that they may be specifically adapted to interact with a different electrically and/or electronically supported apparatuses and/or peripherals and/or with different types of electrically and/or electronically supported apparatuses and/or peripherals.

In an aspect, the present invention provides a device providing an embedded system configured to copy software elements or entities present on the system and transmit the copy of the software entity to systems of the same type with which the device of the invention is connected.

In an aspect, the present invention provides a an embedded system and/or device configured to copy software elements or entities present on the system and transmit the copy of the software entity to systems of the same type with which the device of the invention is connected, wherein each of said software elements or entities preferably comprise an execution environment, in particular an operating system (OS).

In an aspect, the invention provides an embedded system and/or device comprising at least one interface for connecting the system with an electronically supported peripheral, the system further comprising a basic group of software producing a virtualized environment of the hardware components of the system, said group of software containing a basic operating system (OS) configured to handle access to said hardware components, wherein said system further comprises a communication module configured to communicate with other embedded systems of the same type running a similar basic group of software, wherein said system is configured to receive and/or send, via said communication module, mobile software entities (MEs).

In an aspect, the present invention provides an embedded system and/or device comprising at least one interface for connecting the system with an electronically supported peripheral, the system further comprising a basic group of software producing a virtualized environment of the hardware components of the system, said group of software containing a basic operating system (OS) configured to handle access to said hardware components, wherein said system further comprises a communication module configured to communicate with other embedded systems of the same type running a similar basic group of software, wherein said system is configured to receive and/or send, via said communication module, MEs, said mobile software entities comprise a software execution environment, preferably a full software execution environment suitable to operate on said virtualized environment.

In an aspect, the present invention provides an ME comprising a software execution environment, preferably a full software execution environment, suitable to be run on a virtualized environment. Preferably, the ME and/or its operating system is/are able to run on the virtualized environment provided by the embedded system of the invention.

In an aspect, the present invention provides a data processing device configured to provide an embedded system for an electronically supported peripheral, the device comprising: hardware components including at least two central processing units (CPU) or a CPU comprising at least two cores, and RAM memory; the hardware components further comprising at least one interface for connecting the device to said electronically supported peripheral, via wireless data transfer and/or via cable; the device comprising a local, non-migrating agency software, comprising a hypervisor producing a virtualized environment of at least said one or more of said interface, said agency further containing an operating system (OS) configured to handle access to said hardware components; the device further comprising a dedicated communication module (DCM); wherein the agency software of said device is configured to receive and/or broadcast, via said communication module, mobile or MEs to and/or from other, physically separate devices, said other devices comprising hardware components, an interface, a communication module, and a local, non-migrating agency as defined above, wherein said MEs comprise a software execution environment comprising an operating system that is configured to run on said virtualized environment.

In an aspect, the present invention provides a ME comprising a software execution environment, comprising an operating system suitable to be run on a virtualized environment provided on the device and/or system of the invention.

In an aspect, the present invention provides the use of the embedded system of the invention for the dissemination of software, in particular software for supporting, maintaining and/or operating electrically and/or electronically supported peripherals.

In an aspect, the present invention provides a method for supporting, driving, controlling and/or operating an electrically and/or electronically supported peripheral, the method comprising the steps of providing an embedded system of the invention configured to support, drive, control and/or operate said peripheral, and connecting the system to the peripheral.

In an aspect, the present invention provides a method for connecting and/or interconnecting electrically and/or electronically supported peripherals, the method comprising the step of connecting said peripherals to the embedded system of the invention, whereby any embedded system of the invention are configured to connect, in an automated manner, with other embedded systems of the invention.

In an aspect, the invention provides the use of an external embedded system for supporting, driving, controlling and/or operating an electrically and/or electronically supported peripheral, preferably peripherals of different kinds and types. Preferably, the external embedded system is the system of the present invention. Preferably, said external system can be configured to potentially operate any and/or a large variety of different types of electrically and/or electronically supported peripherals, on the basis of software components common to all said external embedded systems.

In an aspect, the invention provides a system, network and/or platform comprising and/or involving a plurality of devices in accordance with the invention.

In an aspect, the invention provides the use of embedded systems of the invention for connecting and/or interconnecting electrically and/or electronically supported peripherals.

Further aspects and preferred embodiments of the invention are defined herein below and in the appended claims. Further features and advantages of the invention will become apparent to the skilled person from the description of the preferred embodiments given below.

### BRIEF DESCRIPTION OF THE DRAWINGS

FIG. 1 schematically represents an embodiment of the embedded system of the present invention.

FIG. 2 schematically represents the principle architecture software components of an embodiment of an embedded system of the present invention.

FIG. 3 shows a first exemplary embodiment of a network comprising systems as illustrated in FIG. 1, the network connecting a storage system and a multimedia output device.

FIG. 4 shows a further exemplary embodiment of a network comprising systems as illustrated in FIG. 1, the network connecting a weather station and a watering installation.

FIG. 5 shows an exemplary embodiment of using the system of the invention to build up a personal computer.

FIG. 6 shows an exemplary embodiment of a network of systems of the invention, the network being useful in messaging.

FIG. 7 shows an embodiment of a network illustrating the dissemination of software entities within the network.

FIG. 8 illustrates an embodiment of a protocol establishing connections between systems as illustrated in FIG. 1.

FIG. 9 illustrates an embodiment of a protocol for propagating software between systems as illustrated in FIG. 1.

FIG. 10 illustrates an embodiment of a protocol for receiving broadcasted software in a device as illustrated in FIG. 1.

FIG. 11 illustrates an embodiment of the process of erasure of a ME from the system in accordance with an embodiment of the invention.

FIG. 12 shows an exemplary software and hardware architecture of a system according to an embodiment of the invention.

### DETAILED DESCRIPTION OF THE PREFERRED EMBODIMENTS

The present invention provides an embedded system adapted and/or configurable to be connected to an electrically and/or electronically supported peripheral.

The embedded system is preferably in the form of a device providing the embedded system. The expressions “embedded system” and “device” are used exchangeably in this specification.

The embedded system is preferably a combination of hardware and software that is adapted and/or configurable to accomplish a particular function. The particular function is preferably the support, control, management and/or operation of said electrically and/or electronically supported peripheral. In a preferred embodiment, the embedded system is a device, in particular a data processing device.

The embedded system of the invention is preferably external to the peripheral. In particular, the embedded system is preferably provided in the form of a device that can be connected via an interface on the device to the peripheral.

In this specification, the term “peripheral” stands for electrically and/or electronically supported peripheral. The terms “peripheral” and “appliance” may be used interchangeable and are considered to have the same meaning in accordance with the invention. In an embodiment, a “peripheral” is a device that is operated and/or functions with the aid of software, in particular firmware, and/or contains electronic equipment for operation. Preferably, the peripheral contains electric and/or electronic equipment for functioning and/or operation. The software/firmware preferably interacts with the electric and/or electronic equipment. The operation of a peripheral may be automatic and/or by a human operator. The peripheral may in principle be any type of apparatus, device, machine, system, accessory and/or equipment. In an embodiment, the appliance and/or peripheral is an external device.

The present invention is not limited to any particular peripheral. Indeed, one of the advantages of the concept of the present invention is that it provides a multi-purpose embedded system, wherein the word “multi-purpose” expresses that the embedded system can be configured for use with any type of peripheral. Interestingly, this is achieved on the basis of software that is common to all embedded systems of the invention.

For the mere purpose of illustration, an exemplary list of peripherals is provided hereinafter: Examples of peripherals include vehicles, such as trolleys, trucks, transporters, such as pallet transporters, automobiles, airplanes, trains; data processing machines in general, such as computers, laptops, personal computers; household peripherals, such as washing machines, TVs, hi-fi systems, dishwashers, ovens, cookers, coffee machines, food processors, illuminating; computer accessories, such as storage disks, screens, computer mice, joysticks, keyboards, consoles including game consoles; heating and/or cooling installations; vending machines; military equipment; cameras including video cameras; mobile phones; smart phones; computer pads; devices comprising touchscreens in general; robots; manufacturing machines, such as filling machines, packaging machines, assembling machines and/or robots in general; measuring devices and apparatuses, measuring stations, such as weather stations; audio equipment; electric music instruments; amplifiers; audio devices in general; equalizers; just to mention a few types of peripherals that can be operated with firmware and that are encompassed by the present invention.

The embedded device and/or system of the invention comprises hardware components and software components. Hardware components preferably encompass one or more selected from the group consisting of: one or more CPUs or a single or multi-core CPU, RAM memory, one or more selected from ROM, EPROM, and flash memory, and interfaces for operating an electrically and/or electronically supported peripheral. Hardware components preferably also encompass a motherboard. The hardware components preferably also encompass a dedicated communication module (DCM).

The embedded system preferably comprises a CPU, preferably a multi-core central processing unit (CPU), or a plurality of CPUs. In an embodiment, the embedded system comprises two CPUs or a dual core CPU. In other embodiments, the embedded system comprises four, six, eight, ten or more cores, for example a quad-core, hexa-core, octa-core CPU, and so forth. The processors (CPUs) may but need not necessarily be configured for running with and/or assisting the operation of virtualized environments, such as, for example, the Intel® VT CPU and/or ARM Cortex-A15 family based CPUs.

One reason of providing a multi-core CPU is that it allows separation of tasks in dependence on the software that sends instructions to a CPU. For example, the invention envisages the exclusive access to one of said cores by the basic group of software of the system, and in particular by the permanent, local software execution environment of the system of the invention.

The embedded system preferably comprises a RAM memory, in which programs on the system can be loaded.

The embedded system preferably comprises one or more selected from the group consisting of ROM (read-only memory), EPROM (erasable programmable read only memory), and flash memory, and equivalents thereof.

The embedded system preferably comprises an interface for connecting the system to the peripheral. The interface may be adapted to wireless connection or connection via a cable. In an embodiment, the system comprises a port, for connecting a cable that is further connected to the peripheral. In other embodiments, the interface enables a wireless connection, for example via Bluetooth, Wi-Fi, or equivalent wireless connections. The interface may comprise a wireless module for connecting the system to the peripheral.

In an embodiment, the device of the invention comprises more than one interface 2. Interfaces may be selected, for example, from wireless interfaces for network connections, audio interfaces, HDMI interfaces, USB ports, and combinations of two or more of the aforementioned. These interfaces are preferably virtualized by a hypervisor of said agency.

In an embodiment, an embedded system may be dedicated to and/or configured to operate with a particular peripheral. In this case, the embedded system is specifically adapted to support a particular type of peripherals or a particular model of a type of peripherals. For example, an embedded system of the present invention may be configured to support a particular type or model of cars, for example cars from a particular manufacturer, or even to a particular model of the cars of a particular manufacturer. This configuration of the system of the invention to support a particular device is preferably determined at least in part by the basic group of software, which contains software, such as backend drivers, etc. for supporting and/or operating the particular peripheral.

The embedded system of the invention preferably comprises a communication module the purpose of which is to allow communications between embedded systems of the present invention. In particular, the communication module is provided for the sending and/or the receipt of mobile software entities.

The expressions “mobile software entity” “mobile entity” are abbreviated as ME in this specification.

In particular, an embedded system of the invention can establish communication with any other embedded system of the same type via said communication module, wherein said “embedded system of the same type” is a system of the present invention, but a different device unit. Accordingly, “an embedded system of the same type” is another, physically separate device. Such a different device is preferably an embedded system having a different unique identifier.

In a preferred embodiment, the communication module comprises a wireless connection and/or a wireless module. In an embodiment, said wireless module is configured to send and/or broadcast MEs, at least in part by wireless communication. Furthermore, the wireless module is preferably configured to receive MEs from at least one of said other devices, at least in part by wireless communication. Consequently, the MEs are received in as far as they are broadcasted by another device that is in reach of the device receiving the ME, and/or vice versa.

The wireless module is preferably configured to directly communicate with another embedded system of the invention of the same type at least in part by wireless communication.

In an embodiment, the invention encompasses (or does not exclude) that the interface for communicating with one or more peripheral be the same as the communication module for communication with other systems of the same type. In this case, the system of the invention needs to be configured to manage the use of the interface with respect to the different connections (peripheral, other systems of the same type).

In a preferred embodiment, however, the communication module is different from the interface connecting the system to one or more peripheral. In a preferred embodiment, said communication module is preferably a dedicated communication module (DCM), configured to communicate specifically with other embedded systems of the same type running a similar basic group of software, preferably configured to communicate uniquely and solely with other embedded systems of the invention.

A DCM is particularly preferred for various reasons, including safety reasons. A DCM allows separating access to peripherals from the communication between connected systems of the invention. Accordingly, dissemination as detailed herein does preferably not affect the interaction with the peripheral.

Each embedded system of the present invention preferably comprises an own, unique identifier. The unique identifier can be considered as a serial number, identifying any individual embedded system of the invention. The unique identifier thus also distinguishes different embedded systems of the same type, which systems are otherwise preferably constructed identically, for example as specified in this specification. It is also noted that an embedded system of the present invention may communicate, preferably via said communication module, with other embedded systems of the invention, whereby said other embedded systems may be connected to peripherals of different types. Accordingly, an embedded system connected to a weather station, for example, may communicate, via said communication module, preferably said DCM, with an embedded system connected to an irrigation system.

In a preferred embodiment, the device of the invention is a physically separate entity that can be connected with the peripheral. The device preferably comprises an own housing. The housing preferably comprises one or more ports and/or interfaces, as described elsewhere in this specification, for connecting the device with peripherals. Such connections or interfaces may be present in the form of plug sockets or outlets. If the interfaces are all wireless interfaces, the device may comprise no such socket or outlet.

In another embodiment, the device of the invention may be realized in the form of a board that can be integrated into another device, for example a peripheral as discussed elsewhere. In this case, an own housing may be absent.

The embedded system preferably comprises further hardware components as necessary to perform the computer programs, protocols, and/or functions as described in the present specification.

The embedded system preferably comprises a basic group of software. In the present specification, the basic group of software is generally referred to as “agency”. The agency is preferably a fixed and/or permanent software part of the embedded system. Preferably, the agency is not a migrating and/or disseminated software part of the system of the invention, in contrast to the mobile software elements. The agency is thus a local, non-migrating software part of the device. While the agency may comprise one or more software entities that may be reprogrammed, up-dated or replaced, the agency is preferably part of a protected area of the embedded system. Preferably, the agency may only be modified by particular access rights, for example from the manufacturer. Some main components of the agency will be discussed in more detail elsewhere in this specification.

The device is configured to send and/or receive MEs to and from, respectively other devices of the same type, which means other, physically separate devices comprising hardware and software components as defined in this specification, in particular an agency software and a dedicated communication module as defined in this specification and/or in accordance with the invention.

For the purpose of the present specification, “other, physically separate devices”, “other embedded systems” or just “other devices” are devices of the invention which preferably comprise hardware components, an interface, a communication module, and a local, non-migrating agency as defined in accordance with the invention. In an embodiment, “other devices” have a different unique identifier and thus are thus not only physically separate devices, but are also distinctive from each other by way of said identifier.

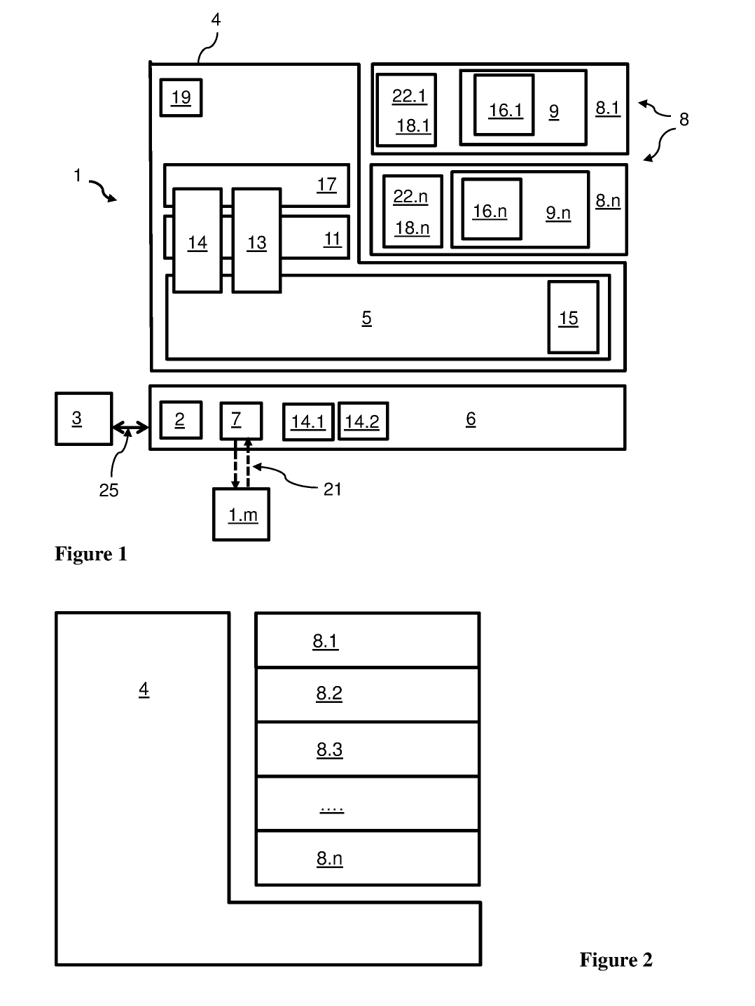

Preferred embodiments of embedded systems of the present invention, and in particular the agency, will be discussed in more detail with reference to FIGS. 1 and 2.

FIG. 1 shows an embodiment of a device 1 providing an embedded system of the invention, comprising hardware components 6 and the agency 4. The peripheral that is supported by the embedded system 1 is indicated with reference numeral 3, which is connected to the system 1 via interface 2. The device 1 may comprise more than one and in particular a plurality of interfaces 2, which may be selected from the interfaces specified elsewhere in this specification, for example. Reference numeral 7 indicates the communication module, preferably a DCM, which allows the system 1 to communicate with other embedded systems of the same type 1.m. The hardware components 6 in FIG. 1 comprise a dual core microprocessor, 14.1, 14.2.

In a preferred embodiment, the system 1 of the invention comprises a unique identifier 19. The unique identifier is preferably suitable to identify the system 1 and each of said other embedded systems 1.m of the same type. The unique identifier 19 allows thus to distinguish the embedded systems of the same type 1, 1.m from each other. The unique identifier 19 is preferably enshrined within the software, in particular of the agency 4. In other embodiments, the unique identifier 19 may also be part of the hardware components 6.

The agency 4 comprises software, in particular a hypervisor 5 that produces a virtualized environment. Some hardware components that are accessible exclusively by the agency 4 are preferably not virtualized. Such hardware components preferably include the DCM 7 and/or the first and second CPU or core 14.1. In an embodiment, the said dedicated communication module (DCM) 7 is not virtualized by said hypervisor 5 and/or said DCM 7 can be accessed by said agency 4, preferably exclusively by the agency 4. The DCM can most preferably not be accessed by a ME 8. In particular, reference numeral 5 indicates the hypervisor of the agency 4, which creates the virtual environment of the device 1. The agency 4 further comprises an own operating system 11, which is preferably characterized by the presence of kernel software.

In a preferred embodiment, the hypervisor 5 is a type 1 hypervisor. In another embodiment, the present invention encompasses or does not exclude that the hypervisor is a type 2 hypervisor.

In a preferred embodiment, the agency 4 comprises a user space 17, which comprises storage space. The user space 17 preferably further comprises software for operating the appliance 3. Since the system 1 is particularly configured and/or programmed to support a peripheral 3, the agency 4 preferably controls all instructions sent via interface 2 to the peripheral 3. The software for controlling the support of peripheral 3 may be provided in the operating system 11 and/or in the user space 17, or, more generally, anywhere within the agency 4.

Since the embedded system may be configured and/or programmed to operate a large variety of different peripherals, the software for controlling and/or operating a particular peripheral generally differs between the embedded systems of the invention in dependence of the peripheral to be operated. The present specification provides more detail with respect to software that is common to embedded systems of the invention regardless of the peripheral to be operated. The present specification does not provide particular detail with respect to the software that may be suitable to operate any particular peripheral. Such latter software may be known or may be conceived in dependence of how particularly a peripheral is to be operated.

In a preferred embodiment, the agency 4 and its software components run on a dedicated CPU core. Preferably, other processing is performed on other, separate cores. This applies to the embodiments where the system 1 comprises a multi-core CPU, for example a dual core CPU 14.1, 14.2. Accordingly, the agency 4 and its software components run on a first CPU or core 14.1, while MEs run on the second or other CPU or core 14.2. The first core and/or CPU is preferably dedicated to the agency 4, and/or the second core and/or CPU is preferably dedicated to the mobile entities. In this regard, callback functions called up by the agency 4 in MEs preferably run on the first core 14.1 dedicated to the agency 4. The other processing performed on other cores or CPUs, such as on the second CPU or core 14.2, includes, for example, processing of instructions from MEs 8, as disclosed in more detail elsewhere in this specification. In a preferred embodiment, said first and second cores or CPUs 14.1 are not virtualized by said hypervisor 5. In an alternative embodiment, one of said CPUs, for example the second CPU may be virtualized. In an embodiment, said at least two central processing units CPUs or said at least two cores 14.1, 14.2 comprise a first CPU or core 14.1 and a second CPU or core 14.2, and wherein said first CPU or core 14.1 can be accessed by said agency 4, preferably exclusively by said agency 4. The first core or CPU can most preferably not be accessed or used directly by a ME 8.

The embedded system 1 of the invention is configured to receive and/or send MEs 8. The embedded system 1 can run the MEs 8 that are present in its memory. The system 1 may contain one or a plurality of MEs, for example a first, second, third, fourth, etc., up to an nth ME 8.1, 8.2, 8.3, 8.4 . . . 8.n. Small n may be an integer from 1-1000, preferably 1-100, more preferably 1-10, for example, so that an according number of mobile entities may be present on the system. There is no particular limit with respect to the number of such mobile entities, and the limit of 1,000 above is just used for illustration. Generally, the software code of a particular ME 8.n is run on the particular system 1 on which it is present. However, this is not mandatory, or not with respect to all software, as discussed in more detail elsewhere in this specification. The present invention preferably provides means for regulating in an autonomous manner the presence and/or activity of mobile entities in a particular system of the invention, in particular by way of software common to all mobile entities of the invention and/or software that allows the agency 4 to interact with all mobile entities 8 present on a particular system 1.

In a preferred embodiment, the mobile entities 8 comprise a software execution environment 9, preferably a full software execution environment. Preferably, said software execution environment is suitable to run on said virtualized environment 5. Preferably, said full software execution environment is an environment comprising an operating system (OS) 9. Preferably, the OS 9 of the ME 8 can be run on the virtualized environment 5 provided by the system 1 and in particular by the agency 4.

For the purpose of the present invention, an OS and/or a full software execution environment is a software environment which comprises application and kernel software. Preferably, the full software execution environment/OS also comprises drivers, in particular frontend drivers (in the case of OS 9 of the ME) for addressing hardware and/or the peripheral 3.

It is understood that an OS encompasses one, several or all selected from: software managing inter process communication (IPC), software controlling the access to the hardware components, software that manages the memory, software that schedules processes and programs, and the management of user space applications. This characterization of an OS preferably applies to the OS 11 of the agency 4 (the agency OS) and/or to the OS 9 of the ME 8 (the ME OS) running on virtualized hardware components.

Regarding drivers, the agency OS 11 preferably comprises backend drivers while the ME OS 9 comprises frontend drivers. In an embodiment, the agency comprises a backend driver, configured to provide, together with a frontend driver provided by said ME, a peripheral driver for supporting, controlling, managing and/or operating said electrically and/or electronically supported peripheral.

Examples of OSs 9 of the ME 9 may include any OS, such as, for example Linux OS. Any OS may be developed or derived from existing OS for use as the agency OS 11 or the ME OS 9 of the invention. Preferably, the OS 9 of the ME 9 is adapted and/or configured to interact with the agency, for example to run the callback functions that are part of the mobile entities. Preferably, the OS 9 is para-virtualized so as to be configured to run on top of the hypervisor 5.

Preferably, the mobile entities 8 comprise further software code. Such further software 22.1, 22.n, 18.1, 18.n is generally adapted to assist in the support, management and/or operation of said peripheral 3.

A main purpose of the mobile entities 8 is to provide software assisting, together with the agency 4, in the support of the peripheral 3. In case a ME 8 present on a particular system 1 is not useful for assisting in the operation of the peripheral, it is expected that the ME will be erased, as will be specified elsewhere in this specification. The further software 22 may comprise data 18, which may in any way be used by the system 1 and/or the peripheral 3. In the embodiment shown in FIG. 1, a first ME 8.1 contains software 22.1 and 18.1, wherein the nth ME 8.n contains software 22.n, 18.n.

In an embodiment, the ME 8 comprises one or more application software 22, which is configured to be run on said operating system 9 of the ME 8. The application software is preferably configured to support, control, manage and/or operate an electrically and/or electronically supported peripheral 3 that can be connected to said device 1. More generally, application software is generally any software achieving any goals possibly involving the use of external devices available in the local device. The application software 22 may comprise embedded software for operating the electronically supported peripheral 3. An application software 22 is preferably a software other than an OS. An application software thus preferably lacks the above mentioned software elements characterizing an OS. Any application software is generally not defined or limited to any particular computer language and may be provided in any computer language.

Preferably, mobile entities 8 of the invention have access to the second core or CPU 14.2 of the device of the invention. The preferred architecture of the device and the mobile entities of the invention imply that, under usual operation of application software on a ME 8, program instructions of the ME are preferably executed on the second core or CPU 14.2. In an embodiment, program instructions of mobile entities may also be emulated by the agency, involving the hypervisor and the OS of agency, to run on a virtualized CPU. It is preferred, however, that the mobile entities have direct access to the second core/CPU, and that the latter is not virtualized.

Since the one or more interfaces 2 providing access to the peripheral or peripheral 3 are virtualized, the agency keeps the control of all activities of the mobile entities related to the control and operation of the peripheral by the ME 8.

In an embodiment, the device of the invention comprises software 13 configured to produce a copy of one, several or all MEs 8 present in the device 1 and to broadcast said copies via said communication module or DCM 7.

The system 1 sends and/or receives mobile entities 8 via the communication module 7, which is preferably a DCM. The mobile entities are thus sent to and/or received from other embedded systems (1.1-1.m) of the same type to all other embedded systems of the same type 1.1-1.m that are connected to a particular system 1 of the invention. Preferably, several systems 1, 1.1, . . . , 1.m, of the present invention communicate with each other via said communication module so as to form a network. Mobile entities 8 are preferably distributed over said network of connected systems of the invention.

In a preferred embodiment, the system of the invention 1 is configured to establish a network 10 among systems of the same type 1, 1.1, 1.2, . . . , 1.m. Preferably, the system establishes the network automatically and/or autonomously.

In an embodiment of the system 1 of the invention, said agency 4 is configured to automatically and/or autonomously detect, by way of said communication module or DCM 7, other systems of the same type 1.m. In an embodiment, said system 1 is configured to establish and maintain a list of all other systems of the same type 1.m which are accessible by the system via the DCM 7. In particular, the system 1 comprises and/or runs software and/or protocols for automatically establishing connections to devices of the system type, thereby providing said network 10.

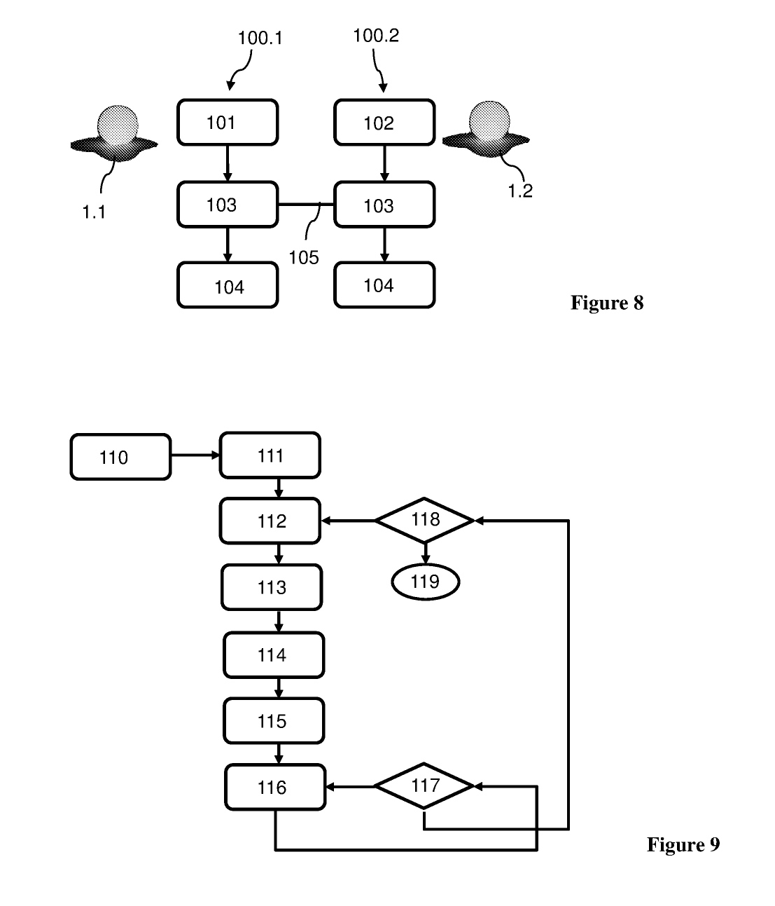

FIG. 8 illustrates exemplary protocols 100.1, 100.2 for establishing communication and/or providing a network of systems of the present invention. The protocol 100.1 is run on system 1.1 of the invention, whereas protocol 100.2 is run, preferably at the same time, on system 1.2 of the invention. Systems 1.1 and 1.2 are other devices of the same type and thus devices of the invention. The protocols 100.1, 100.2 run preferably within the respective agency 4 (FIGS. 1 and 2). Furthermore, both devices 1.1 and 1.2 preferably run, independently, both protocols 100.1 and 100.2.

In a first step 101, a “ready” message is sent from system 1.1 through the DCM 7. Under step 102, system 1.2 waits for a wireless connection, using the DCM. System 1.2 receives the “ready” message from system 1.1 and a connection 105 is established in step 103. The connection may be established, for example, on the basis of a simple network protocol, for example based on TCP/IP (Transmission Control Protocol/Internet Protocol). In the third step 104, both devices up-date their list of systems 1, 1.1, . . . , 1.m, that are visible to a particular system, in that they can be directly reached via the DCM. For example, the visible systems are systems of the invention that are in the same neighborhood with respect to each other. Each system of the invention preferably maintains a list of other systems of the invention (of the same type) that are remotely accessible via the DCM 7.

A network of systems of the invention is preferably established between systems that are in reach with each other, that is, which can establish connection with each other via the communication module 7. The possibility of establishing a connection between systems of the invention may be dependent of the physical distance of devices of the invention, on the range of the communication module (for example in case of wireless communication modules), on the possibility of making use of other available networks, such as the internet, and the like.

In accordance with another embodiment, the agency software of a particular device 1.1 sends or broadcasts mobile software elements 8 without establishing, beforehand, a particular connection with other devices 1.n, for example without first sending a “ready” message as indicated above. The memory snapshots of the local MEs 8 are just broadcasted. The broadcasted MEs are accompanied by a signal or pattern, which allows another device 1.n to recognize the signals to be a broadcasted ME 8. Accordingly, when broadcasting said MEs, the agency and/or the DCM 7 is configured to produce a recognition signal and/or pattern.

In accordance with an embodiment, the agency is configured to automatically and/or autonomously detect, by way of said communication module or DCM, whether a ME is broadcasted by one of said other devices. The DCM 7 of any device 1.1 and 1.n is preferably configured to detect broadcasted MEs. In particular, the DCM regularly detects a radio signal and screens the detected signals for patterns that identify the signal to represent a ME 8 broadcasted by another device.

Generally, it is noted that the DCM 7 be configured to scan radio frequencies so as to detect radio signals. The DCM is preferably configured to analyse the radio signals that are detected. Furthermore, the DCM is configured to adjust a broadcasting and/or receiving frequency when a particular frequency turns out to allow successful transmission of an ME.

In accordance with this or similar embodiments, it is not necessary that a particular connection be established between devices of the invention. A receiving device 1.n simply receives MEs broadcasted by another device 1.1 as long as the other device 1.1 is sufficiently close and/or the signal is sufficiently clear to receive the ME 8. In other words, MEs are broadcasted and received between devices 1, 1.1, 1.n that are in reach of each other.

In an embodiment, the device is configured to establish and maintain a list of all other devices which are accessible by the system via the communication module or DCM. In In other embodiments, such a list may thus be absent in the device of the invention. If present, the list may remain internal to the DCM. Preferably, if present, the list is not visible to the mobile entities. If a particular device 1 creates and/or maintains a list of devices 1.1, 1.n that are in reach of the device 1, any identifier of the DCM 7 may be used, such as a WIFI identifier, like a service set identifier (SSID), for example.

In terms of timing, it is noted that any device of the invention 1 is preferably configured not to start broadcasting an ME 8 if it at the same time detects a signal identified as an ME broadcasted by another device. On the other hand, a ME is preferably broadcasted when devices 1.1-1.n in reach of the device 1 do not broadcast an ME. In this regard, the DCM may be configured to control when precisely MEs on the device are broadcasted.

The present invention provides an embedded platform for enabling efficient dissemination of software, including OS migration, and live OS migration.

In a preferred embodiment, said agency 4 comprises software 13 configured to produce regularly and in an automated manner a copy of one, several or all MEs 8 present in the device 1 and to broadcast said copies via said communication module and/or DCM 7. The broadcasted mobile entities 8 are preferably sent to and/or received by one, several or all embedded systems of the same type 1.m. This protocol 13 is preferably performed autonomously at pre-determined and preferably regular intervals by the agency software 4.

For the purpose of the present specification, the terms “automatically” and/or “autonomously” indicate that the performance of such protocols does not require confirmation by an operator, for example.

Preferably, the software 13 for producing a copy and broadcasting said copy of a ME 8 is provided in said agency 4 and is triggered and run autonomously by said agency 4, and/or wherein said agency 4 is configured to copy and send said MEs at a frequency determined by said agency 4. In a preferred embodiment, said mobile entities 8 on said device 1 are free of software that is capable of triggering and/or starting any software for copying and/or broadcasting said ME via said dedicated communication module 7.

As indicated, the frequency of migration of mobile entities (copying and broadcasting) is determined by the agency 4, and may be part of the configuration of the agency 4, which cannot be modified by a ME 8.

Generally, an embedded system 1 is configured to send copies of said mobile entities to all embedded systems of the same type 1.m that are visible to the particular embedded system 1. According to basic protocols, copies are preferably prepared from all mobile entities 8, 8.1, . . . , 8.n, present on the system of the invention. Exemplary exceptions to the above rules are discussed elsewhere in this specification.

In an embodiment, the software 13 performs the steps of: optionally suspending a ME 8 running on the device 1; getting a memory snapshot of the optionally suspended ME 8 so as to obtain a copy of the ME; and, broadcasting said memory snapshot via said communication module/DCM 7, preferably to all embedded systems of the same type 1.m which can be reached via said communication module 7. The agency is preferably configured to repeat these steps until all residing mobile entities are copied and broadcasted, unless a particular ME has provided information limiting its migration, as disclosed elsewhere in this specification.

For example, a ME may provide information to the agency, which causes the agency stop broadcasting the ME, or which causes the agency to copy and broadcast a ME for a defined number of times only at the most. Other possibilities of information provided by the ME may include stopping the execution but continuing the broadcasting of the ME. Possibilities of a ME for limiting its migration are disclosed elsewhere in this specification, for example with respect to the hypercall functions stop_propagate( ) and skip_activation( ).

The memory snapshot represents a copy of the ME, wherein the ME is suspended. The snapshot thus preferably represents a non-running and/or inactive copy of the original ME. When being received in a new system of the invention, the suspended ME (memory snapshot) may be resumed, for example at the very position where it has been suspended when the memory snapshot was established.

As mentioned above, the original ME that is copied may be suspended before establishing the snapshot. In an embodiment, after the step of getting the memory snapshot, said software 13 or agency 4 performs the step of resuming the activity of the suspended ME 8 at the position where it was suspended, such that the ME 8 on the device continues running during said steps of broadcasting said memory snapshot.

In an alternative embodiment, the original ME to be copied is not suspended and the memory snapshot is thus established on the basis of the active, running and/or non-suspended ME. This has the advantage that the step of copying and disseminating mobile entities can be performed without interrupting the operation of mobile entities on the system of the invention.

Even in case a ME is suspended for the purpose of making a memory snapshot, the ME can be resumed at the precise position where it has been suspended. Broadcasting of the copy of the ME can thus take place while the original ME has resumed activity and is running. Accordingly, the present invention provides for a live, on-line dissemination of software, and in particular full execution environments.

FIG. 9 shows an exemplary protocol for the dissemination of mobile entities 8 by the system 1 of the invention. The protocol is preferably running within the agency 4, for example as part of software 13 (FIG. 1).

In step 110, the agency 4 waits a predetermined amount of time before running the protocol. For example, the delay time could be 24 hours or less, 12 hours or less, 6 hours or less, preferably 2 hours or less, more preferably 1 hour or less, and most preferably 1 minute or less. In a preferred embodiment, the delay time is less than 3 seconds, preferably less than 2 seconds, for example, less than or equal to 1 second. After the delay time, a start step 111 is established for a particular running ME 8 present on the system 1. For example, the first ME 8.1 on the system 1 is identified. In step 112, the ME 8.1 is prepared for being copied. If necessary, the operation of the ME 8.1 is suspended. The agency 4 preferably checks, as part of this or a separate step, if the ME 8.1 is in a stable, coherent state allowing suspension and/or copying. Preferably, the step of suspending a running ME may be accomplished via a callback function called by the agency 4 in the ME, preferably in the OS of the ME. The suspending callback function has the purpose of letting the ME reach a stable state with regards to its device activities. It is thus understood that the ME is in preferably in a stable, suspended state before proceeding to the next step.

Under step 113, the agency 4 gets a memory snapshot of the ME 8.1. The memory snapshot is a copy of ME 8.1. If the program run on the ME 8.1 has been suspended under 112, the ME is resumed in step 114, so that the particular ME 8.1 continues operation. This is in accordance with the purpose of live migration in accordance with preferred embodiments of the invention.

Step 115 is optional and/or concerns a particular embodiment of the invention. In step 115, the protocol in FIG. 9 may use the information concerning the list of visible other devices, which is maintained by the system 1, for example as illustrated in FIG. 8. For example, step 115 comprises getting or reading the information from a particular storage area. The system thus determines the available connections to other devices of the same type 1.m via said DCM 7.

In step 116, the agency 4 broadcasts the snapshot of the ME that was copied under step 112. If, in step 115, a list of other devices was established, the snapshot is broadcasted to a particular agency 4.m of another system 1.m of the same type, which is visible and thus present in the list.

Alternatively, the copy of the ME 8.1. is simply broadcasted under step 116, independently of an available connection to or other devices 1.m. In this case, step 115 may encompass checking whether a ME is actually being received or broadcasted from another device 1.m. In this case, the device 1 waits until broadcasting from other devices has stopped and proceeds with step 116 only once the DCM is available in the sense that it is not occupied with receiving an ME from another device 1.m or with analyzing wireless signals potentially being a ME broadcasted from another device.

In a preferred embodiment, the memory snapshot and/or the copy of the ME is not decomposed before broadcasting. Preferably, the copy of the ME is broadcasted as one entity, for example one continuous broadcasting event.

Step 117, is similar to step 115 and is optional. In particular, the device 1 may check. in step 117, if there is another available connection and, if so, sends the snapshot to the next system 1.m that is visible (back to step 116). If, in step 117, no further system of the same type is found, the dissemination of the particular ME 8.1 is terminated and the protocol proceeds to step 118.

Under step 118, the agency 4 checks if there is a next and/or further ME, for example ME 8.2 running on the system 1. If so, the protocol proceeds again to step 112, this time with respect to the next ME. As one can see, the protocol is repeated by step 118 of system 1 until a copy of all mobile entities 8, 8.1, . . . , 8.n is prepared and disseminated. In step 118, if no further running ME is found, the protocol of FIG. 9 is ended in step 119.

In accordance with the invention, the MEs may be broadcasted while they are executed and/or in their current execution state. Accordingly, the present invention encompasses strong migration of software.

For the purpose of clarification, it is noted that the letter “m” may refer to the total number of systems 1 of the invention, for example in a network 10. At the same time, the reference numerals 1.m, 4.m and 8.n may also refer to anyone particular or individual system, agency, and ME in accordance with the invention. For example, the numerals 1.m, 4.m and 8.n may refer to a particular system, agency or ME, respectively, as defined by a respective unique identifier. Accordingly, the reference numeral 1.m is used herein also to refer to anyone particular system of the invention within the network of systems 1.1, 1.2, . . . , 1.m., so that m may be any integer of 1 to m.

In a preferred embodiment, the agency 4 comprises software 14 dedicated to the receipt and implementation, in the receiving device, of a ME 8 received from another device.

In a preferred embodiment, the agency is configured to run a sequence or set of protocols with respect to a ME that is newly received on the device, following its broadcasting from another device.

For the purpose of this specification, a newly received and/or arrived ME will be referred to as a “new ME”. An ME that is already running and activated on the device on which a new ME arrives will be referred to as “residing ME”.

Preferably, the sequence of protocols comprises one, two or more callback functions, which are called by the agency in a new ME, and which preferably run on the first core and/or CPU 14.1 dedicated to the agency. The callback functions are preferably part of the new ME and are preferably present in the OS 9 of the ME.

In a preferred embodiment, said agency 4, 4.m and/or said interacting software provides an application programming interface (API) 15 for interacting with said ME 8. The API allows communication between the agency 4, 4.m and MEs 8. The API is preferably provided by the hypervisor 5. In an embodiment of the invention, the ME comprises protocols, functions and/or programs that can be called by said agency 4 and/or said API 15. Preferably, said agency 4 is configured to call callback functions of/in said MEs 8, in particular via the API. The callback function for suspending an ME has already been mentioned herein above.

Preferably, said callback functions in the ME can be called exclusively by or possibly via the agency 4. In an embodiment, said callback functions 16, called by the agency 4, are executed on a first CPU or first CPU core 14.1 of said CPU, which is configured to be accessible exclusively by the agency of said device 1.

In the present specification, the term “function” is used to refer to one or more protocols, functions and/or programs that have a defined purpose and which may be directed to the interaction of the agency 4 with the mobile entities 8 or vice versa and/or the interaction between mobile entities 8.

In an embodiment, the sequence of protocols run with respect to a new ME comprises:
A first callback function 124, in which the agency provides information with respect to the local hardware environment and/or the peripheral connected to the device. This function is generally referred to as “pre-activate function”, since it takes place before the activation of the new ME on the device. This function preferably gives the new ME the opportunity to check the compatibility and/or utility of the ME on the device on which it has just been received.
A second callback function 125, in which the agency provides information with respect to the other (residing) MEs that are already present on the device and which are already activated. This second function will be referred to as “cooperate function”. This function gives a new ME the opportunity to send and/or possibly receive information to/from residing mobile entities. This function further preferably gives the new ME the opportunity to be coupled with a residing ME.
a resume function. In this function, the agency activates the new ME.
an optional third callback function, in which the activated, new ME is given the possibility to run program code via the agency core once it has already been activated. This function is generally referred to as “post-activate” function in this specification. The scope of the ME code to be conducted within this function is not defined. The new ME can conduct configuration steps.
an optional fourth callback function, in which the activated ME is given the possibility to interact with residing MEs as described with respect to the second callback function. This callback function may also be referred to as “second cooperate function” or “cooperate-post”, the difference to the first cooperate function being that the new ME has been activated and has thus more resources on the device and/or possibilities.

For the purpose of clarification, if the optional third function is absent and the optional fourth function as defined above is present, the optional fourth function becomes the third function.

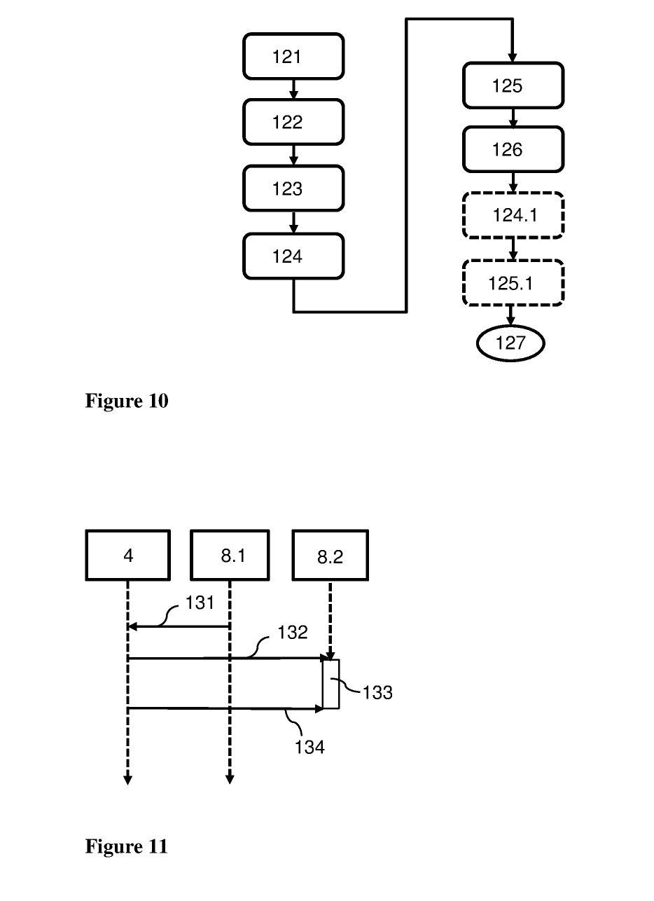

FIG. 10 illustrates protocols for the receipt and implementation of mobile entities by a system 1, 1.m of the present invention. For example, the protocol shown in FIG. 10 is run on all systems 1.m of the invention that have received a snapshot of an ME, for example a new ME 8.n following the protocol shown in FIG. 9. This type of protocol as shown in FIG. 10 is preferably run by the agency, for example by the software 14 schematically shown in FIG. 1.

For the purpose of illustration, the receiving device running the protocol illustrated in FIG. 10 is referred to with reference numeral 1.m, so as to better illustrate the receipt of the ME 8.n by system 1.m, broadcasted by system 1. In reality, all systems of the invention 1, 1.m etc., are preferably configured to send and receive mobile entities 8, 8.1, 8.n, thereby contributing to the collaborative environment that is the objective of the present invention. A residing ME is referred to with reference numeral 8.m.

In step 121, the agency 4.m of a receiving system 1.m, which runs the protocol of FIG. 10 becomes aware that a new ME snapshot 8.n has been received. For example, the agency 4.m receives a notification message from the remote (connected, visible) agency 4 that has sent the ME snapshot 8.n. In step 122, the agency 4.m preferably determines one or more free memory slots providing the necessary amount of memory, suitable to harbor the snapshot received. Preferably, memory slots are RAM memory slots. Then, in step 123, the snapshot is preferably loaded into the slot identified and/or determined in step 122. At this stage, the agency preferably configures the memory of the new ME. This will allow the agency 4, in optional subsequent steps, to execute some particular code of the new ME on the CPU dedicated to the agency 4.

Once the snapshot of the ME 8.n is loaded into a fee memory slot of a receiving agency 4.m, preliminary steps and/or checks are preferably conducted in step 124.

In a preferred embodiment, said agency 4 and/or said ME 8 comprises software that is capable of determining whether a particular ME entity 8.n present on the system 1 is adapted to interact, support, manage and/or operate with said electronically supported peripheral 3. In other words, the system 1.m and/or the MEs 8, 8.n, or both together, comprise software that allows determining if a new ME 8.n is of any practical and/or technical use for the system 1.m on which it has been received.

As indicated above, said functions preferably comprise a function which allows checking the compatibility and/or adaptability of a new ME to (a) operate in the system 1 and/or to (b) interact with said electronically supported peripheral 3 connected to said system 1.

Preferably, the pre-activate function gives the new ME the possibility to determine whether it is configured or adapted to operate in the device 1 and/or to operate said electronically supported peripheral 3 connected to said device. The pre-activate function preferably includes transferring local information to the new ME, such as available peripherals (versions, features, etc.), such that the ME can perform some compatibility checks. This local information is preferably provided by way of an argument when the agency 4 calls the callback pre-activate function in the new ME. In particular, the argument may contain a physical memory location, and the new ME may map the memory location internally. The memory location preferably comprises information with respect to the local environment of the device, such as the peripherals connected to the device, the interfaces, for example versions numbers, etc. The new ME 8.n, in turn, is free to use the information that was rendered accessible by the agency 4.m to validate itself and check the compatibility and/or suitability of the new ME 8.n for this particular system 1.m. Preferably, the new ME comprises software code for conducting the compatibility checks using the information provided by the agency. Typically, in step 124 encompasses performing tests of compatibility of the virtual devices required by the new ME 8.n for running in the system 1.m.

The pre-activate function preferably gives no visibility to other residing mobile entities, which may be provided by the cooperate( ) function discussed elsewhere.

Following the pre-activating step 124, the agency 4.m may pass to step 125. This is actually optional, because the new ME may have already triggered a protocol for it being deleted, in case it has determined that it is of no utility to a particular device on which it has arrived.

In an embodiment, the ME 8, in particular the OS 9, comprises a cooperate function 125, e.g. entitled cooperate-pre(list_ME), which is called up by said agency 4 and which causes or enables said new ME 8.n to interact with and/or to pass information directly to a residing ME 8.m present on the device 1.m.

In an embodiment, the agency is configured to call said cooperate callback function 125, e.g. named cooperate-pre(list_ME), in a new ME 8.n for enabling the transfer of data from the new ME 8.n to a residing ME and/or vice versa. At this stage, the cooperate function may take preferably place before the activation of the new ME. Optional or possible cooperation after activation of the ME will be discussed further below.

In particular, when calling the cooperate callback function, the agency 4.m. preferably passes, as an argument, a list of all residing mobile entities (list_ME) that are running on system 1.m to the newly arrived ME 8.n. This list may simply comprise the numbers (integers) of the residing MEs.

Data exchange and/or communication between a new and a residing ME, for example in step 125, may take place in several manners. A possibility of such communication is described in more detail herein below. Since this communication takes place within the initial implementation protocols of the agency run with respect to a new ME, all protocols are configured to run on the CPU dedicated to the agency 4. As a consequence, a residing ME can continue with the execution of its application software for operating a peripheral, for example.

If the agency has called the cooperate callback function, the new ME may contain and/or run code for allowing for transfer of data and/or information to a particular residing ME. To this end, the new ME is preferably configured to call a hypercall function directed to a particular ME. This hypercall function may be referred to as “cooperate(noME)”. It contains the reference to a particular ME, such as the number of an ME, hereinafter the “called ME”, which in this case is a residing ME. It also contains a reference to a storage location of the calling ME, as will be discussed below.

Preferably, the “cooperate(noME)” function is sent by the new ME to the agency 4/hypervisor 5. The hypervisor 5 is configured to redirect the contact request to the residing ME. In particular, the hypervisor 5 preferably call a callback function in the residing ME (e.g. entitled cooperateCB(noMEcalling). This callback function contains the number of the calling ME (the new ME) as an argument. Preferably, the reference to the storage location contained in the hypercall function is also transferred with the callback function.

As part of the “cooperate(noME)” function, the calling (new) ME indicates the very residing ME with which interaction is intended. Furthermore, as an argument, the function preferably includes a physical memory location where the new ME may have stored data. This memory location information is transmitted by the callback function cooperateCB(noMEcalling) of the hypervisor 5. In this manner, the residing ME is allowed to access the data by mapping internally the data at said physical memory location. As a consequence, the residing ME has direct access to data provided by the new ME. It becomes clear that, by sending the memory location when calling the hypercall “cooperateME” function, the new ME gives access to the data of the new ME that was stored at this location. Since this was under the control of the new ME, the new ME “knows” or controls the data to which the residing ME gets access in this manner.

In an embodiment, the ME of the invention is configured to make available data and/or information directly to another ME residing on the device of the invention.

When the “cooperateME” function is called at the hypervisor, the latter generally performs a memory context switch for running code of the residing ME on the CPU dedicated to the agency 4.

It is noted that the residing ME may also provide access to its data to the new ME. For example, the residing ME may be configured to change the argument value related to the physical memory location. The new ME generally knows the argument, because the function “cooperateME” was called from the new ME. The new ME may thus in turn map the memory at the indicated (changed) physical location and thereby gain access to data provided by the residing ME. In this manner, the new and residing MEs may exchange data.

Once the cooperateCB(noMEcalling) callback function at the residing ME following the new MEs cooperateME function, the new and the residing MEs are coupled and all kinds of data exchange and interaction becomes possible. Preferably, the device of the invention and/or the mobile entities are configured to allow for direct data exchange and/or collaboration between MEs. The two MEs are preferably coupled by the calling of functions.

As becomes apparent, the coupling between two MEs, a new and a residing in the frame of a cooperate function is preferably accomplished by and/or via the hypervisor 5 and all codes run on the first core/CPU dedicated to the agency 4.

Once the “cooperateME” callback function is ended, the hypervisor conducts the memory context switch to turn back to code of the new ME within the “cooperate(noME)” callback function called by the agency 4 in the new ME. The new ME may then be coupled with another residing ME. If the cooperateME function has been called by the new ME with respect to all residing MEs, the new ME may end the cooperate function 125 (cooperate(noME)) called by the agency 4. Of course, the new ME may also trigger particular functions as a result of the interaction with a particular residing ME 4. For example, the new ME may decide to cause its erasure from the system or the erasure of another, residing ME, as discussed elsewhere in this specification.

Accordingly, in an embodiment, the ME 8.n is configured to call a function 131 (“cooperateME”) with respect to another ME 8.m present on the device 1, allowing the new, calling ME to pass some arguments to the residing ME. As indicated above, this preferably takes place via the hypervisor, who receives the new and calling MEs function and starts callback function in the residing ME.

The advantage of this way of interaction is that the automated deposition of data by a residing entity into a predefined “shared memory space” or “tuple space” of the agency 4 is not necessary, although this is not excluded. The interaction between mobile entities in accordance with the invention is direct and specific, and allows transfer of data that is specifically useful for a ME seeking for information.

It is noted that the cooperate function 125 that may be called by the agency 4.m is preferably run while the new ME has not yet been activated. One may say that, in this state, the possibilities and/or resources of the new ME to interact with a residing ME present on the device are to some extent limited. For this reason, the cooperate function 125 may be a first or pre-activation cooperate function (“cooperate-pre”), and the ME may optionally contain a second or post-activation cooperate function 125.1 (“cooperate-post”), as described further below.

In some embodiments, the information retrieved in steps 124 and/or 125, has an impact on the further behavior of the new ME 8.n on the device 1.m.

In an embodiment, a newly arrived ME is activated by resuming its activity, for example resuming its software or program code, from the position where it has been suspended when the memory snapshot was prepared before the ME was disseminated.

In step 126, the new ME 8.n is activated and starts running on the system 1.m. The activation of a new ME comprises or consists of resuming the ME at the position where the ME from which the new ME has been copied was suspended. The new ME thus resumes from the very position where the original ME in the broadcasting device has been suspended (FIG. 9).

Further with respect to FIG. 10, as indicated above, the agency 4.m may call up an optional third callback function 125.1, referred to as post-activate function. At this stage the new ME has been activated and may use the scheduler of the OS 9.n and/or the allocation of memory, for example. The third callback function has the purpose of giving the new, activated ME the possibility of running program code on the core/CPU 14.1 of the agency. Any code may be conducted at this stage, for example configuration steps, for example with respect to interfaces, peripherals, and/or memory, etc.

Further with respect to FIG. 10, as indicated above, the agency 4.m may call up an optional second cooperate function 125.1 (or a fourth callback function), after the activation of the new ME. The second cooperate function called up by the agency 4.m, e.g. referred to as cooperate-post(list_ME) may result in more extensive interaction between the MEs. For example, a new ME may preferably use a hypercall function directed to the hypervisor (“cooperate(noME)”) to trigger the process of interaction with a particular residing ME. This may take place in exactly the same manner as indicated above with respect to the first cooperate function. In particular, the hypercall function preferably comprises a reference with respect to a called, residing ME, and the hypervisor calls a callback function such as cooperateCB(noMEcalling) in the targeted ME. Once the new, activated and the residing activated MEs have been coupled by the hypervisor, more sophisticated data exchange becomes possible. In particular, since the new ME 8.n is now activated, the second cooperate function may use the scheduler of the OS 9.n and/or the allocation of memory of the newly arrived ME 8.n, which was not the case before step 125. For example, the two coupled MEs may set up other, more direct communication channels, which may not necessarily pass by the hypervisor.

Step 127 illustrates the termination of the protocol that is run upon the receipt of a new ME 8.n. In analogy to FIG. 9, the protocol in FIG. 10 is preferably repeated for each newly received ME 8.n, until all newly received mobile entities are treated, for example activated. The step of activation 126 is not mandatory and can be subject to one or more conditions, one of which will be exemplified in more detail elsewhere in this specification. In case a new ME is not activated, the optional second cooperation function 125.1 will preferably not be called up by the agency 4.m. In the same way, the “post-activate function” (124.1) will not be called up either by the agency.

In an embodiment, any one or more, preferably all the functions of the protocol in FIG. 10 are running exclusively in a ME that has been newly arrived on the device of the invention. These functions, such as the cooperate functions 125 and 125.1 called by the agency 4, are not called up by the agency in residing mobile entities, which have received previously, which have gone through the protocol of FIG. 10 already and/or which have already been activated. Accordingly, the device of the invention preferably comprises a protocol which may be triggered specifically by the agency preferably only once in any newly received ME for the purpose of activating the ME. In an alternative embodiment, the callback functions preferably called by the agency in a newly arrived ME may also be called up in already activated mobile entities that are residing in the device.

In an embodiment, the agency is configured to call or start the callback functions and resume protocol in the order indicated above, such as (pre-activate)-(cooperate)-(resume)-(optional postactivate)-(optional second cooperate), or (pre-activate)-(optional cooperate)-(resume)-(cooperate)-(optional postactivate).

In another embodiment, the “first” or “preactivation” cooperate function is absent and only the post-activation cooperate function is present.

In an embodiment, the ME and preferably its OS 9 comprises the callback functions mentioned and is configured to run these functions once they are called by the agency 4. In an embodiment, the ME does not conduct any particular activity or even no activity within one or more of these functions. While the agency is configured to call the callback functions in the ME, the latter contains the code related to these functions, and may, in principle, contain no code at all.

In an embodiment, the mobile entities 8 are preferably present in RAM memory of the system 1 only. In an embodiment, the system 1 is preferably intended to be in constant connection with a source of electric power. Systems intended to be used for non-portable and/or stationary peripherals are preferably adapted to be connected to the electricity power supply network or system and/or a battery. In an embodiment, the device comprises a cable for connection to the power supply system. If the device is adapted to the operation of a portable peripheral (tablet, smartwatch, etc), the device is preferably equipped with a portable battery, preferably a rechargeable battery. In an embodiment, the device may be powered via the rechargeable battery of the portable peripheral 3.

In case the system 1 is switched off and or the power source is interrupted for any other reason, the mobile entities 8 present in the device may be lost and generally need to be received anew via the concept of dissemination in accordance with embodiments of the present invention.

It is noted that the steps as illustrated in the protocols of FIGS. 9 and 10 are preferably run by the agency 4 and thus preferably by the core of the CPU 14.1 that is dedicated to the agency 4. The activated mobile entities 8.1, . . . , 8.n running on the system may preferably run on another CPU or another core of the CPU. Since the mobile entities 8 are run on a virtualized environment, the control with respect to the allocation of running programs is accomplished by the hypervisor 5.

An embedded system 1 has thus been disclosed above, which is preferably in the form of a data processing device 1, and which is configured to be connected to a peripheral 3 so as to support, manage and/or operate the peripheral, in a similar and/or analogous way as done by typical embedded software and/or firmware. The embedded system of the invention thus comprises embedded software for operating a particular peripheral. The embedded system preferably comprises software that is particular adapted to support and/or operate said particular peripheral, for example a particular peripheral selected from the list of exemplary peripherals provided above. The embedded system can thus assume the same specific function as any preexisting embedded system or software, with one difference being that the system of the invention is a device that is separate from and/or external to the peripheral and thus is configured to be connected to the peripheral. In addition, the embedded system of the invention provides a platform for the dissemination of software. At least some if not all software is broadcasted and received in the form of MEs. The MEs are preferably broadcasted via a separate communication module, by which embedded systems of the invention are connected. As the skilled person will appreciate, the present invention provides an embedded platform for the efficient dissemination of software, thereby allowing for rapid updating of software and/or firmware, in particular embedded software. The present invention provides a highly cooperative environment, formed by a network of the embedded systems of the invention and the dissemination of software. A further advantage of the embedded system is that it can be configured to be operated with any peripheral. The invention thus provides a multi-purpose embedded system and multi-purpose applications and/or software. Some of these advantages are also achieved by the agency software, which provides a virtualized environment allowing the live migration of complete execution environments, generally including operating systems (OSs), through MEs. The mobile entities are preferably spread by means of cloning and/or copying and broadcasting. Some of the novel features of the present invention reside in the decoupling and/or separation of migration functions from the applications, i.e. from the operative tasks. The decoupling may be achieved by the use of multi-core CPU in the system, by the abstraction of the local hardware by virtualization and/or by the fact that migration involves the migration of complete execution environments (mobile entities) comprising their own OS.

With regard to the origin of mobile entities in a particular systems of the invention before they receive mobile entities via the dissemination described elsewhere, there exist several possibilities. This also applies if a system of the invention does not find any other system of the same type within its reach, so that receipt of mobile entities by dissemination is not or not yet operational. For example, a ME may be present on the system of the invention as purchased, for example on a flash memory which may be contained as part of the hardware of the system. Once the system is started, the first ME will be read from the memory and will be run and broadcasted in accordance with the invention. Another possibility is that a ME is transferred to a particular system from a connectable and/or disconnectable and removable memory unit, for example a USB stick or a connectable memory card or the like. A ME can then be transferred from the memory entity to the RAM of the system and will thus be run and broadcasted. One may also envisage the loading of a ME via a Bluetooth connection.

In one embodiment, a residing ME present in the system of the invention is configured to check for the availability of injectable mobile entities at determined outside memory locations. “Outside” means here that the memory location is neither part of the system of the invention nor of the network formed by systems of the invention. The “outside” storage location may be a server, which may be accessible by the residing ME via the Internet, for example. The residing ME that is present in the system may download a ME from this outside location and inject it into the system. The connection from the residing ME with the outside storage location may be made via a specific wireless connection module, for example. In this embodiment, a new ME in a system may originate from a residing ME. A function exemplified as agency_ctl(cmd) in Table 1 below may then be called up by the ME to inject the new ME into the system.

In another embodiment, an agency 4 of a system is contacted from an outside source, for example via Wi-Fi, Bluetooth or cable, and a new or first ME is then transferred by the agency into a local system of the invention. In this case, a communication channel that used by the mobile entities may be used for downloading the new ME from the outside. This includes communication channels via interface 2, which is in principle foreseen for communication with the peripheral 3. The system of the invention may, of course, comprise several such interfaces 2. In this case, the communication module 7 is preferably not used.

The above embodiments are not exclusive one with respect to the other and the invention encompasses several possibilities for up-loading or injecting a ME into the system of the invention, for example in case the system is not connected to a network because no system of the same type is in reach, or the systems that are in reach with each other do not possess mobile entities yet.

The system 1, in particular the agency 4, may comprise a function, which allows the up-loading of a ME from any storage place, for example from an external, removable storage medium. The function may be activated by the user or may also be activated automatically when the storage medium is connected to the system 1.

Dissemination of mobile entities via a server is preferably not envisaged by the present invention. The present invention seeks to avoid and/or exclude server/client based systems, or any type of hierarchic systems. Therefore, in a preferred embodiment, the present invention excludes a system of the invention operating as a server or a base station for disseminating mobile entities of the present invention. The network of the invention is preferably free of a server or base station.

The fact that entire execution environments are disseminated in the form of mobile entities provides several advantages. For example, when a ME is erased, it can be erased completely, with no software part remaining in the system (not considering the possibility of data that may have been transferred to the agency or to another ME). By disseminating and/or erasing complete execution environments, the invention provides important advantages in terms of the stability. A ME is actually pre-configured with a complete set of applications and is injected within the system; with such a system, there are no complicated installation or configuration procedures to be made by the end user.

The system of the present invention provides an extension of existing objects and/or peripherals, whether or not they are connected to the Internet or to any other type of other network. The present invention makes it much simpler to make use of and/or connect a heterogeneous environment and/or completely different peripherals.

Herein below, some further embodiments of software and/or functions executed in connection with the MEs 8 will be discussed in more detail. This software and/or these functions may be dedicated to interactions with the local agency 4 and/or between different local software entities 8.1, . . . 8.n. A “local” agency is the agency on the very embedded system on which a particular ME is present. In a preferred embodiment, these functions may be available to all running applications/mobile entities. Furthermore, some of this software and/or these functions may determine the behavior and/or persistence of a ME on a system 1 and/or its interactions with the local agency and/or the other mobile entities.

In an embodiment, each ME comprises a set of embedded functions, which enables various functionalities which may have an impact on the existence of the ME within the ecosystem. The “ecosystem”, in this context, refers to the combination and/or collection of particular mobile entities present at a given time on a particular, local embedded system of the invention. One or more of such functions may be functions that are called up by the agency, for example by way of the API provided by the agency, as discussed herein above, for example with respect to functions, which are called up by the agency upon receipt of a new ME.

In an embodiment, the ME comprises functions that can be called up by the basic group of software/agency 4, for example via an application programming interface (API) 15, and/or wherein said basic group of software 4 calls up at least one of said functions in any newly received ME 8.

In an embodiment, said functions comprise a first function, which has the goal of determining whether the particular ME 8 is configured to operate in the system 1 and/or to interact with said electronically supported peripheral 3 connected to said system 1. In an embodiment, said basic group of software/agency 4 and/or said ME 8 comprises software that causes the erasure of a ME 8 if it is not suitable to interact with said at least one electronically supported peripheral 3.

In an embodiment, the ME 8 may further contain software 22 capable of interacting with electronically supported peripherals 3 that can be connected to said system. In this case, the continued existence of the ME 8 on the system 1 may depend on further factors, such as the version, grade and/or age of the software 22 capable of interacting with electronically supported peripherals 3, which is connected to the particular system 1.

In an embodiment, said functions comprise a second function, said second function causing said ME 8 to interact with the other MEs 8.n present on the system 1.

In an embodiment, the basic group of software and/or agency 4 and/or said ME 8 comprises software that determines whether a ME 8 is to be erased or to be kept on the system.

Herein below, some protocols, functions and/or programs that can be run with respect to a ME are discussed. In a preferred embodiment, said protocols, function and/or programs are embedded in the ME 8, preferably in each ME of the present invention. Accordingly, they are part of the software that allows the agency and the ME to interact, and/or which allows the mobile entities present in a particular device/system to interact with each other. The functions allowing interaction between the agency and the mobile entities make preferably use of the API provided by the agency. The functions may be in the form of a message and or an instruction containing arguments with respect to how the function should be executed by the agency.

One or more of these protocols, function and/or programs are callback functions, which may be called by the agency. Preferably, such callback functions are run on the CPU dedicated to the agency. The functions that are not callback functions are functions that are preferably called by the mobile entities. Preferably, the functions make use of the API provided by the agency.

In an embodiment, a ME may comprise or call a function that causes the erasure of a ME present in the system/device of the invention. This function preferably contains information with respect to which particular ME is to be erased. The function may contain the information that another ME is to be erased, or that the ME calling the function is to be erased (“self-killing”). Accordingly, the function may preferably be called by a particular ME. For example, the function may have the name kill an ME(anME), wherein the ME to be destroyed is indicated within the brackets (anME), for example the number of the ME to be erased. When a ME calls this function at the agency 4, the latter erases the ME mentioned in brackets. The number may also indicate the very ME that is calling the function (“self-killing”).

In the present specification, exemplary command names of particular functions, optionally followed with a mode or general information written in brackets, are presented in italic letters in this specification. The command name kill an ME(anME) is an example. The selected command names are illustrative only and should not be constructed as limitative with respect to the present invention, as the skilled person may easily use different names for calling similar or identical functions.

In an embodiment, the ME may comprise a function which terminates the program code of a ME. This function is preferably called back by the agency when a ME is to be erased. This function allows stopping the operation of a ME on the device before erasure, for example. One may also envisage situations other than erasure where the operation of a ME is to be stopped and/or the ME is to be inactivated.

In an embodiment, a ME may comprise or call a function that causes the stop of the basic protocol of copying and broadcasting of a particular ME. In this particular example, the ME may continue being active and running within the particular system on which it is present, but the protocol as illustrated in FIG. 9 is not executed for the particular ME that has called up the function. An illustrative command name of the function may be, for example stop propagate( ) When a ME calls up the function within the agency, the latter will ignore this particular ME when proceeding with the regular dissemination of all (remaining) mobile entities present on the device. This function may be called up, for example, if a particular ME is particularly destined to a defined, particular system of the invention. Once the ME has identified that it has arrived at its destination, for example based on the unique identifier 19 (FIG. 1), it may call the function stop propagate( ) because further dissemination is no longer necessary.

In an embodiment, a ME may comprise or call a function that causes the ME not to be activated within a particular system 1. This function may be provided in several modes. For example, the non-activated ME may be disseminated regularly, for example following the protocol shown in FIG. 9. In this case, the ME will stay resident in a particular system for dissemination only, but not for being executed within the system. Alternatively, the ME may be disseminated once and will then disappear. Other possible modes can be envisaged, for example the dissemination for a particular number of times, as defined within the function (for example, 1, 2, 3, 4, 5, times only), before being erased. An exemplary command name for this function could be skip activation(broadcast mode), wherein the expression within brackets defines the broadcast mode.

In an embodiment, each ME has a unique identifier. The unique identifier identifies any particular ME 8. Any newly programmed and/or disseminated ME will have an own identifier, similar to the serial number of a physical device.

Preferably, the unique identifier of the ME, if present, does not change upon copying and broadcasting a ME 8. In other words, independently of the number of copies of a ME produced and broadcasted, the unique identifier preferably remains the same. The unique identifier is thus preferably copied as such when preparing the memory snapshot. The unique indentifier is thus also independent of the data 18 that may be stocked and broadcasted with a ME. This allows the device and or a ME of the invention to know whether a newly arrived ME is the same as a ME that is already on the device. The “cooperate” function discussed elsewhere may be used to determine if a newly arrive ME contains additional data that was absent in a residing ME having the same identifier.

The ME may comprise and/or call a function which allows it to obtain a list of and/or reference to the mobile entities present on the device, and possibly other information such as the particular unique identifier of any, several or all mobile entities present on the device. This function may be called as part of the cooperating function (cooperate(list_ME)), called up by the agency and inducing a ME to cooperate with the other mobile entities present on the device.

It has been specified elsewhere that each system of the invention comprises an own, unique identifier. The ME may comprise and/or call a function which allows it to obtain the unique identifier of the very system on which it is present. This feature may assist in determining whether a particular ME is useful on a particular system on which is has arrived by the dissemination discussed elsewhere.

The function allowing a ME 8 that was newly received on a local system 1 to communicate and/or cooperate with other mobile entities (cooperate(list_ME)) that are resident may be used for controlling the population of mobile entities.

In an embodiment, the information received with the cooperate-function may allow a newly received ME to identify a resident ME that is identical to the newly arrived one. In this case, either the resident ME or the newly arrived one will be superfluous and one of them will be erased. For example, the cooperate-function may be used to identify mobile entities that can be erased and thus avoid crowding of the system.

As another example, the information provided by the agency as part of the cooperate function may allow a newly arrived ME to determine whether it represents an earlier or newer program/application version compared to a residing ME. As a consequence, the older ME version may be erased. This illustrates the use of functions, preferably called up by the agency, allowing cooperation between mobile entities with the goal of stabilizing the ecosystem of mobile entities.

In further or other embodiments, a function of the type cooperate(list_ME) may contain further information with respect to the different residing mobile entities. Such information may allow a newly received ME 8 to determine with which other mobile entities it can directly interact, for example by way of an API specific to a group of mobile entities, allowing a particular group or type of mobile entities to have any kind of further interactions.

Once a ME has determined that it can interact with another ME, any type of interaction can be envisaged, and the present invention does not provide any limitation with respect to interactions between mobile entities on the system 1. In an embodiment, mobile entities can transmit data from one ME to the other. For example, a newly arrived ME may transmit data to a residing ME, or vice versa.

These interactions between mobile entities 8.1, 8.2, . . . 8.n, within a local system 1 may take place as part of the activated and implanted ME or within the pre-activation state of the ME, within said cooperate-function.

Alternatively, these interactions are not limited to the cooperate functions 125, 125.1 called up by the agency.

It is noted that the interactions between mobile entities do not need to be limited in any way, whereas the way the ME and the agency interact is preferably clearly defined, for example by way of the API 15. This is preferred in order to warrant the safety of the system and of the operation of the peripheral 3. It is noted that the agency controls any access of mobile entities to the hardware of the system, and also the access or instructions of a ME with respect to the peripheral.

Another function on the ME allows it to obtain information about the local environment, for example with respect to the peripherals 3, which are connected with the system 1 on which the ME is found, or information with respect to the agency, for example. This function may be asked to the agency, for example via the API provided by the agency. For example, this function may be referred to as local_Env_get( . . . ). This function may also be relevant for determining whether a newly arrived ME is useful for a particular local system.

The ME may comprise and/or call a function which allows it to write something to the agency. This function may be used to deposit data within a dedicated memory space, for example a blackboard-like repository, which is under control of the local agency. The blackboard may comprise or be part of the user space 17 shown in FIG. 1. For example, this function may be referred to as local_Env_put( . . . ). The functions local_Env_put( . . . ) and local_Env_get( . . . ) may be used by mobile elements to deposit and retrieve information/data provided on said memory.

In Table 1 below, exemplary functions, protocols and/or programs, possibly accessible via the API provided by the agency, are listed. The names of the functions are exemplary and illustrative and are not considered to be limitative.

TABLE 1
Exemplary functions of mobile entities and/or the agency of the system of the invention.

| | CB | |
|---|---|---|
| | funct. | |
| Name | (y/n) | Description |
| kill_an_ME(anME) | n | Erase the ME referred by “anME” if the ME exists in |
| | | the local system. If “anME” is null, the calling ME will |
| | | be erased. |
| local_Env_get(. . .) | n | Ask the agency information about the local environment |
| local_Env_put(. . .) | n | Write something to the local agency |
| stop_propagate( ) | n | Stop migrating. The ME pursues its execution but is not |
| | | broadcasted any longer. |
| skip_activation(broadcast_mode) | n | The ME will not be activated within this system, but |
| | | will be disseminated in accordance with the broadcast |
| | | mode. |
| get_SOO_ID( ) | n | Get the unique identifier of the local system/device |
| get_ME_ID( ) | n | Get the unique identifier of an ME |
| pre_activate(info) | y | Asks and allows the ME to retrieve information about |
| | | the local environment/devices/peripherals |
| cooperate- | y | Asks and enables a non-activated ME to cooperate with |
| pre(list_ME) | | other residing MEs |
| cooperate(noME) | n | Called by the new (nonactivated or activated) ME |
| | | referring to a particular residing ME. |
| cooperateCB(noMEcalling) | y | Called by the agency at the residing ME called by the |
| | | new ME (argument: calling ME) |
| post_activate(info) | y | Asks and allows the activated ME to run code |
| cooperate- | y | Provides a completely activated ME the opportunity to |
| post(list_ME) | | cooperate with other residing MEs (argument: nos of |
| | | residing MEs). |
| force_terminate( ) | y | Asks a ME in the system to terminate its execution. |
| agency_ctl(cmd) | n | Asks the agency to perform some internal functions |
| | | such as uploading a new ME |
| | | (AGENCY_ME_UPLOAD) or upgrading the agency |
| | | firmware(AGENCY_FIRM_UPGRADE) |

y/n: yes/no
CB: callback function, generally called by the agency.

The functions that are not callback functions may be in the form of hypercall functions, for example.

In an embodiment, the ME is configured to call functions, in particular hypercall functions, in said a non-migrating agency software 4 of said device 1 via an API 15 provided by said agency 4.

In an embodiment, the ME is configured to call a function 131, in particular a hypercall function, causing an agency software 4 of said device 1 to erase the ME 8 sending the function or another ME 8.n present on the device 1.

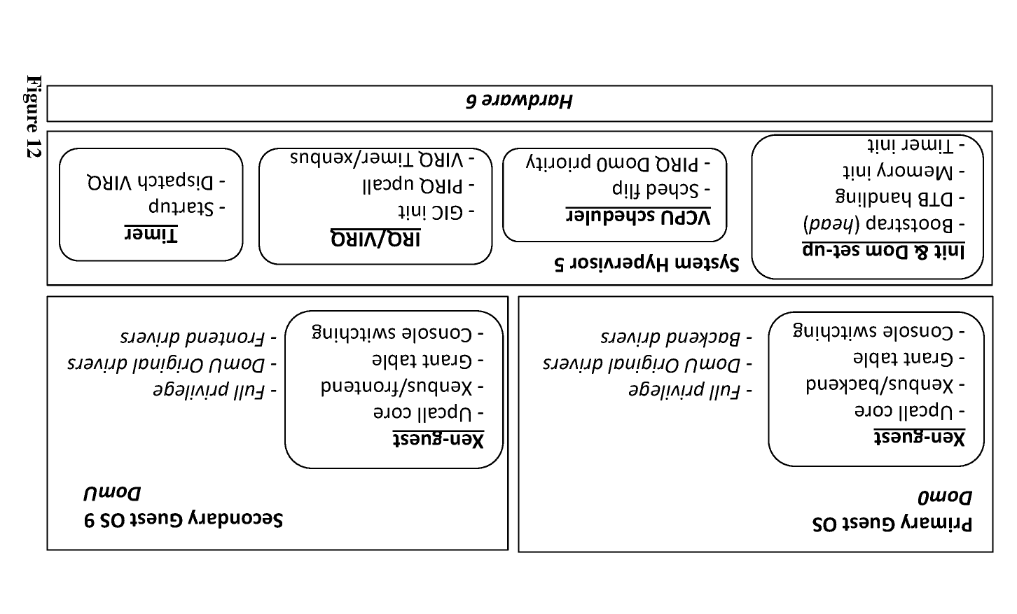

FIG. 11 illustrates a possible scenario of the erasure of a ME 8.2 from the system of the invention. In FIG. 11, the top-down, dashed-lined arrows illustrate activity of the respective software from which the arrow departs, in particular the running of programs. At a particular moment, ME 8.1 activates, via the API of the agency 4, a function corresponding to the function kill_an_ME(anME) in Table 1, specifying that ME 8.2 is to be erased. This is indicated by the arrow with reference numeral 131. Accordingly, the argument “anME” in the function would be “ME 8.2”. The erasure of ME 8.2 may be provoked because it has become superfluous. The reason why ME 8.2 is no longer required is not relevant here and may have been determined by the mobile entities, for example during the step of cooperation, according to a function corresponding to or analogous to cooperate(list_ME) in Table 1. After the function for erasing ME 8.2 is activated in the agency 4, the latter activates the call-back function force_terminate( ) 132 as described in Table 1, which causes the ME 8.2 to stop the execution of its program code activity at 133. After a certain timeout, the agency 4 erases the ME 8.2 from the RAM of the system 1, as indicated by arrow 134.

The kill_an_ME(anME) function is preferably a hypercall function called by the newly arrived ME. Preferably, this function may be called within any cooperate function initiated by agency 4 in a newly arrived ME (FIG. 10). Since this function is preferably run in the frame of the callback function cooperate called by the agency, this erasure function is preferably run on the CPU 14.1 dedicated to the agency. If the same (or another) function is called by the ME during its normal operation, outside a callback function called by the agency, the same function preferably runs on the CPU 14.2 visible to the ME.

As has been illustrated in this specification, and in a preferred embodiment, the ME preferably comprises a set of functions 16 enabling interactions with the basic group of software 4, said set of functions comprising one or more of the group consisting of: a function causing the erasure of a ME present in the system; a function causing a stop of the broadcasting of the ME 8, while keeping the ME 8 active and alive; a function causing a ME 8 not to be activated; a function causing the ME 8 to be broadcasted a particular number of times only; a function causing the transfer of data or information to a predetermined storage on the system 1; a function causing the transfer of data or information from the system 1 to the ME.

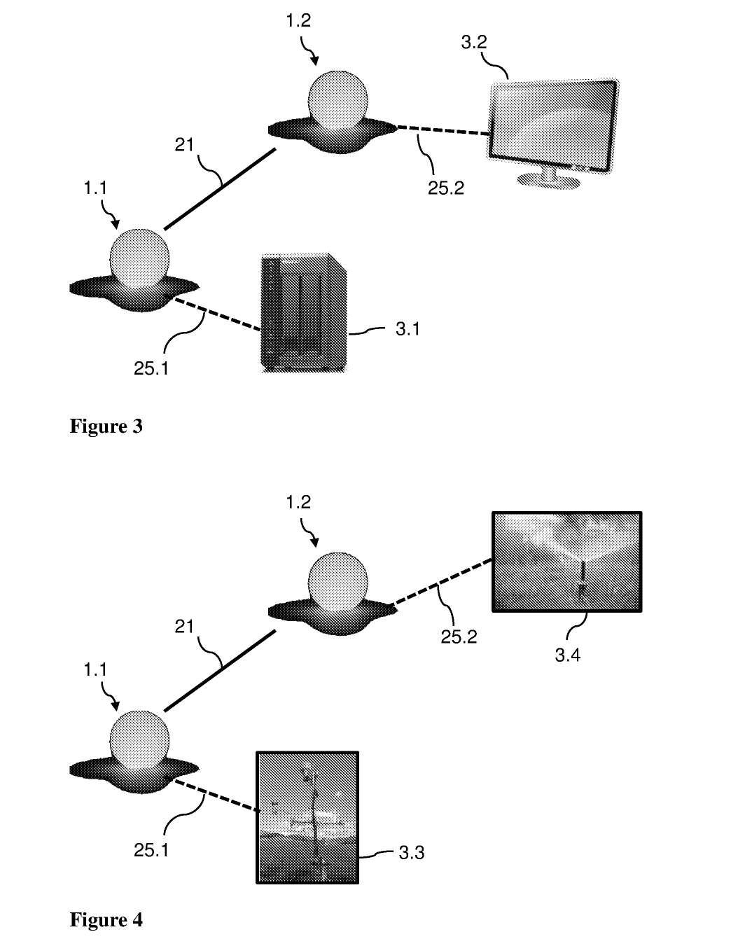

FIGS. 3-7 illustrate the multi-purpose characteristics, advantages and further characteristics of the embedded platform of preferred embodiments of the present invention.

FIG. 3 shows a system 1.1 of an embodiment of the invention, connected via connection 25.1 to storage system 3.1, which represents an exemplary peripheral of the invention. Connections 25.1 and 25.2 may, independently be selected from wired or wireless connections, for example. A second system 1.2 is connected via connection 25.2 to a multimedia output device 3.2, for example a TV or simply a screen in general, the multimedia device 3.2 being a peripheral controlled by the second system 1.2. Systems 1.1 and 1.2 are represented as spheres supported by a socket. The system and/or network may operate as follows: A ME running on system 1.1 reads audio/video contents from the storage system 1.1, bufferizes and outputs to the TV or any multimedia support. Connection 21 is provided by the two communication modules 7 (FIG. 1) of systems 1.1 and 1.2. Said communication module is preferably a DCM. When being transmitted via connection 21 to the system 1.2, the contents read by the ME can be viewed on TV 3.2. Thanks to rapid dissemination of mobile entities, the entire audio/video contents may be transmitted in the form of separate, split parts, allowing continuous display on system 1.2. It is noted that there is no explicit communication between a client and a server. The ME transports the whole running system (execution environment) including bufferized data.

FIG. 4 shows a system 1.1 of an embodiment of the invention, connected via connection 25.1 to a weather station 3.3, which represents an exemplary peripheral of the present invention. A second system 1.2 is connected via connection 25.2 to an irrigation system 3.4, for example of a garden or of an agricultural domain.

Each system 1.1, 1.2 is preferably configured to support and/or operate the respective peripheral 3.3, 3.4.

The systems are configured to send and receive mobile entities via said communication module 7 (preferably DCM) (FIG. 8), wherein reference numeral 21 represents a connection enabling data transfer, which connection may be wireless. The configuration of the device/DCM results in MEs 8 (FIGS. 1 and 2) being regularly broadcasted between the two systems 1.1, 1.2, and other systems 1, which may be connected to one or both of said two systems. Possible other systems are not shown. A ME on system 1.1, and in particular an application software 22.1 (FIG. 1) may read weather-related data from the weather station 3.3, such as the weather to be expected within the close or farther future (for example, within the next 0-7 days), amount of rain to be expected, for example. The weather related data may be stored as 18.1 (FIG. 1) When being broadcasted from system 1.1 to system 1.2, mobile entities containing weather-related data are identifying themselves as (or are determined to be) useful for the system 1.2. They may deposit information about the weather-related data 18.1 on the blackboard 17 of the agency or may transmit the information to other, residing mobile entities, or they may replace previous, residing mobile entities by causing the erasure of the latter. The ME containing the weather-related data may decide to control the watering of the garden in system 1.2. For example, this software is an application software containing algorithms suitable to decide on a watering strategy (volume of water, start and stop times of watering, duration of watering, flow rate, etc). Alternatively, the application software with algorithms for determining watering parameters is contained another ME that is already on the device 1.2. During cooperation of the ME that newly arrived on device 1.2 (broadcasted from device 1.1) can transfer weather related data to the already present ME containing application for watering. In this manner, the present invention provides a manner for connecting peripherals in an intelligent manner. It is noted that any system of the invention, for example system 1.2, may receive many mobile elements from different systems of the same type, but preferably only the mobile elements that are useful for the operation of the peripheral are maintained and/or activated in the system.

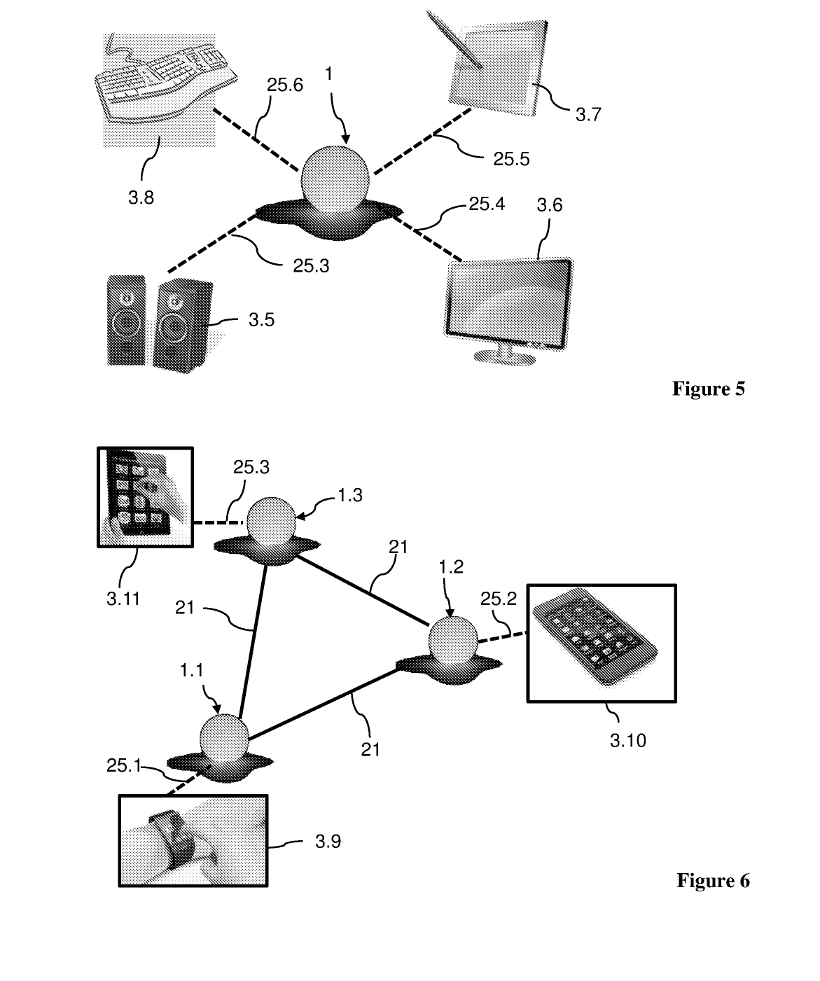

FIG. 5 illustrates another embodiment and/or use of the system of the invention. In this embodiment, several different peripheral devices and/or accessories 3.5-3.8 are connected to the same system 1 via separate connections and/or interfaces 2 (FIG. 1). In the example shown, the system 1 is used to build up an own computer, similar to a personal computer, or any other type of computer. In the embodiment shown, the accessories comprise speakers 3.5, a conventional screen 3.6, a touch screen 3.7, and a keyboard 3.8. In other embodiments, the system of the invention may be connected to any one or more of the peripherals/accessories 3.5-3.8, and possibly to other peripherals. The different peripheral devices and/or accessories are connected to the same system 1 via connections illustrated by broken lines 25.3, 25.4, 25.5, and 25.6, which lines may independently represent wireless or wired connections. The system 1 may thus act as the central processing unit with simple interfaces to any kind of input and/or output devices. Several mobile entities may be present on the system 1. These mobile entities may work together to provide efficient user environment. In this embodiment, the system comprises more than just one interface for connecting a peripheral 3 (FIG. 1), but several interfaces, so that the different input and output devices can be connected to the system 1.

In an embodiment, up-dated software or new data may arrive and be implemented on the system 1 in the form of mobile entities broadcasted from other systems of the same type as system 1, which other systems may be connected to system 1 via the DCM 7 (not shown). Alternatively, the system 1 may also be used as a stand-alone system.

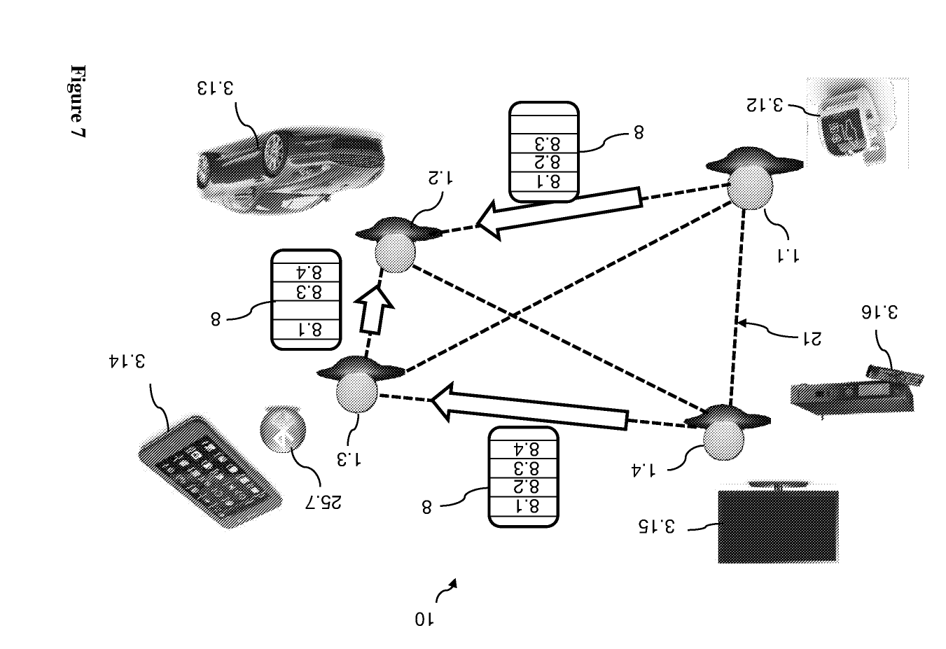

In an embodiment, the system of the invention is used for sharing information, data between different users, including instant messaging, social or professional networking, for example. The sharing of information and/or messages can take place between anonymous users. FIG. 6 illustrates three systems 1.1-1.3, connected to respective peripherals/accessories 3.9-3.11. In accordance with previous embodiments, the connections 25.1, 25.2 and 25.3 may independently be wireless or not. Since the exemplary peripherals 3.9-3.11 are portable, it is preferred that the respective systems 1.1-1.3 are portable, too, and are transported together with and/or in vicinity of the peripherals. For example, the person carrying the computer watch 3.9 preferably carries the system 1.1 along with him/her, for example in a bag or pocket, so that the connection 25.1 remains active. If any one of the connections 25.1-25.3 should be interrupted for some time, it may be reestablished, preferably autonomously, once the respective peripheral 3.9-3.11 is in reach of the respective system 1.1-1.3. This preferably applies to any portable peripheral and to systems of the invention configured to support any type of portable devices.

The networking and/or messaging between holders of the peripherals 1.1-1.3 is preferably conducted via the rapid dissemination of mobile entities 8 as specified elsewhere in this specification, for example as illustrated in FIGS. 9 and 10. The messages, information and/or data gathered on one peripheral, for example watch 3.9, may be carried as part of a ME from the respective system (e.g. system 1.1) to the system connected to another peripheral, for example to system 1.2 connected to the smart phone 3.10, so as to enable instant messaging, for example, or any other type of instant and/or rapid data transfer. This embodiment shows that portable devices, such as electronic watches, mobile phones, computer pads, portable computers and the like may also be used as peripherals with the system of the present invention. The embodiment also illustrates the creation of a network (connections 21) between different, connected systems of the present invention. The network can be established by said DCMs, which are configured to broadcast on the one side and to detect and receive broadcasted mobile elements.

FIG. 7 illustrates the dissemination of MEs 8 within and/or across a network 10 of different systems of the invention 1.1-1.4, each system being connected to one or more peripherals 3.12-3.16. The broken lines 21 represent the connections between the systems 1.1-1.4, via the DCM 7 (FIG. 1), thereby establishing the network 10. The peripherals connected to appropriate systems include a computer watch 3.12, a car 3.13, a smart phone 3.14, a DVD player 3.16 and a screen or TV 3.15. It is noted that system 1.3 is connected via a wireless Bluetooth connection 25.7 to the peripheral 3.14. System 1.4 is connected to two different peripherals, 3.15 and 3.16. FIG. 7 illustrates by way of arrows one or more particular moments where mobile entities 8 are disseminated within the network. The mobile entities that are broadcasted are those that are present on the respective peripherals, and/or those that are intended for dissemination. In FIG. 7, the mobile entities are indicated by way of numbers. For example, system 1.4 sends mobile entities 8.1-8.4 to system 1.3, System 1.3 sends mobile entities 8.1, 8.3, and 8.4 to system 1.2, and system 1.1 sends mobile entities 8.1-8.3 to system 1.2. This illustrates the concept that mobile entities are constantly broadcasted within the network 10.

In FIG. 7, identical reference numbers of mobile entities 8.1-8.4 may refer to identical mobile entities. Alternatively, identical reference numbers of mobile entities may refer to possibly different mobile entities, but to the order of the mobile entities in the device, for example to successive slots in the RAM of the system. For example, ME 8.1 sent from system 1.4 may be a different software than ME 8.1 sent from system 1.1, but the two mobile entities are the first-listed mobile entities within their respective systems, or the mobile entities that are sent first.

FIG. 12 illustrates a more specific, exemplary way of providing a system in accordance with the invention in more detail. Shown are in particular various software components and characteristics of the agency (FIG. 1), which includes the primary guest OS DomO and the hypervisor 5. The secondary guest OS DomU is preferably an operating system pertaining to a ME 8 (FIG. 1) in accordance with the invention.

The basic system of hypervisor and operating system present in FIG. 12 is based on an open source software that is available to the skilled person (EmbeddedXEN hypervisor). In accordance with the present invention the primary guest OS system and the hypervisor 5 are part of the agency 4 (FIGS. 1 and 2), whereas the secondary guest OS 9 in FIG. 12 is part of a ME of the invention.

An advantage of the system of the present invention compared to conventional networks is that a server-client architecture is absent. Interestingly, a base station for receiving alert signals and/or for injecting MEs into a network is not necessary and thus preferably absent. MEs can be entered into any device of the invention and will be automatically distributed.

In an embodiment, the operating system of the ME can potentially be any operating system configured to run on the virtualized environment 5. Any OS may be configured, for example by para-virtualization and preferably implementation of callbacks, for enabling it to run in the hypervisor 5. The ME can contain application software dedicated to any electrically and/or electronically supported peripheral that requires firmware for its operation. Application software contained on said ME can be provided in any programming language supported by said OS 9 contained on said ME.

In an embodiment, the invention also envisages that the agency software be up-dated by dissemination via said communication module 7, preferably said DCM. For example, an agency software up-date may be distributed as part of a ME 7. The agency 4 may contain a function of the type upgrade. In an embodiment, this function may be called by the ME 8 via the API 15, for example, and which results in the replacement of the former agency software 4 by the new one.

1. A data processing device configured to provide an embedded system for an electronically supported peripheral, the device comprising:
hardware components including at least two central processing units (CPU) or a CPU comprising at least two cores, and RAM memory;
the hardware components further comprising one or more interface for connecting the device to said electronically supported peripheral, via wireless data transfer and/or via cable;
the device comprising a local, non-migrating agency software, comprising a hypervisor producing a virtualized environment of at least said one or more interface, said agency further containing an operating system (OS) configured to handle access to said hardware components;
the device further comprising a dedicated communication module (DCM);
wherein the agency software of said device is configured to receive and/or broadcast, via said DCM, mobile or migrating software entities (MEs) to and/or from other, physically separate devices, said other devices comprising hardware components, one or more interface, a communication module, and a local, non-migrating agency as defined above, and
wherein said MEs comprise a software execution environment comprising an operating system that is configured to run on said virtualized environment.

2. The device of claim 1, wherein said at least two central processing units (CPU) or said at least two cores comprise a first CPU or core and a second CPU or core, and wherein said first CPU or core can be accessed exclusively by said agency.

3. The device of claim 1, wherein said DCM and/or said CPU and/or cores are not virtualized by said hypervisor and/or wherein said DCM can be accessed exclusively by said agency.

4. The device of claim 1, wherein said DCM comprises a wireless module, configured to broadcast said MEs, at least in part by wireless communication.

5. The device of claim 1, which is configured to receive said MEs from at least one of said other devices, in as far as they are in reach of the device.

6. The device of claim 1, wherein said agency comprises software configured to produce regularly and in an automated manner a copy of one, several or all ME present in the device and to broadcast said copies via said communication module or DCM.

7. The device of claim 6, wherein the software for producing a copy and broadcasting said copy of a ME is provided in said agency and is triggered and run autonomously by said agency, and/or wherein said agency is configured to copy and send said ME at a frequency determined by said agency.

8. The device of claim 1, wherein said agency is configured to automatically and/or autonomously detect, by way of said communication module or DCM, whether a ME is broadcasted by one of said other devices.

9. The device of claim 1, which comprises software configured to produce a copy of one, several or all MEs present in the device and to broadcast said copies via said communication module or DCM, wherein said software performs the steps of: suspending an ME running on the device; getting a memory snapshot of the suspended ME so as to obtain a copy of the ME; and, broadcasting said memory snapshot via said communication module or DCM.

10. (canceled)

11. The device of claim 1, wherein said agency comprises an interacting software providing an application programming interface (API), wherein said agency is configured to call functions contained on said MEs by way of said API, and wherein said agency is configured to call callback functions with any ME that has been newly received via said communication module on the device.

12. (canceled)

13. The device of claim 11, wherein said callback functions are contained in an operating system of said MEs and/or wherein said callback functions on the ME called by the agency are executed on a first CPU or core, which can be accessed exclusively by said agency.

14. (canceled)

15. The device of claim 11, wherein said agency is configured to call, in an ME that has newly been received in the device, one or both selected from the group consisting of:
a “pre-activate” callback function, wherein calling said “pre-activate function comprises providing access with respect to the local environment, preferably with respect to the peripheral connected to the device, giving the newly received (new) ME the possibility to check compatibility with the local environment, in particular peripherals and/or interfaces of the device; and
a “cooperate” callback function in a new ME in the device for allowing the new ME to transfer data to a residing ME and/or to render data of the new ME accessible to a residing ME.

16. (canceled)

17. The device of claim 1, wherein said agency is configured run a sequence of protocols with respect to a ME received newly on the device, the sequence comprising:
a first callback function, called in a new ME, in which the agency provides information to the new ME with respect to the local hardware environment and/or the peripheral connected to the device and for allowing the new ME to determine if the new ME is configured to operate the peripheral connected to the device;
a second callback function, called in a new ME, in which the agency provides information with respect to the residing MEs that are already present on the device and providing the new ME the possibility of interacting with one or more MEs that are already present on the device;
a resume function, in which the agency activates the new ME;
an optional third callback function, called in a new and activated ME, giving the new and activated ME the possibility to run program code on a core/CPU dedicated to the agency; and
an optional fourth callback function, called in a new, activated ME, in which the new ME is provided the possibility to interact with one or more MEs that are already present on the device.

18. A mobile software entity (ME) comprising a software execution environment, comprising an operating system (OS) suitable to be run on a virtualized environment provided on the device of claim 1.

19. The ME of claim 18, which comprises one or more application software, which is configured to be run on said operating system of the ME and/or to support, control, manage and/or operate an electrically and/or electronically supported peripheral that can be connected to said device.

20. The ME of claim 18, wherein said OS comprises a plurality of callback functions, which are configured to be called by a local, non-migrating agency software of said device by way of an interacting software and/or API.

21. The ME of claim 18, wherein said OS comprises a plurality of callback functions, which are configured to be called by an interacting software of a local, non-migrating agency software of said device, and wherein said callback functions are executed on a first CPU or first CPU core of said CPU, which is configured to be accessible exclusively by the agency of said device.

22. The ME of claim 20, wherein said callback functions comprise one or more selected from the group consisting of:
a first callback function, comprising software code for determining if the ME is configured to operate one or more of the peripherals connected to the device, on the basis of information provided by the agency of said device; and
a second callback function, comprising software code for rendering data of the ME directly accessible to a residing ME and/or for interacting directly from a residing ME present on the device.

23. (canceled)

24. The ME of claim 18, which is configured to call a function in another ME present on the device, the callback function containing information related to the calling ME and providing the other, called ME access to said data and/or information comprised in the calling ME.

25. The ME of claim 18, which is configured to call functions, in particular hypercall functions, in said a non-migrating agency software of said device via an API provided by said agency.

26. The ME of claim 18, which is configured to call a function, in particular a hypercall function, causing an agency software of said device to erase the ME sending the function or another ME present on the device.

27. (canceled)
